(19) United States
(12) Patent Application Publication
(10) Pub. No.: US 2026/0289391 A1
(43) Pub. Date: Sep. 24, 2026

(54) IDENTIFYING COLLECTIVE COMMUNICATION MESSAGES IN ETHERNET NETWORK FABRICS

(71) Applicant: Dell Products L.P., Round Rock, TX (US)

(72) Inventors: Jonathan Peter Streete, South San Francisco, CA (US); Joseph LaSalle White, San Jose, CA (US); Martin Gilbert Belanger, Cameron, NC (US); Mihai Lazar, Ottawa (CA); Erik Philip Smith, Douglas, MA (US)

(21) Appl. No.: 19/086,530

(22) Filed: Mar. 21, 2025

(51) Int. Cl. G06N 20/00

(52) U.S. Cl. CPC G06N 20/00

(57) ABSTRACT

A method for managing performance of an ML workload includes: receiving: ML workload telemetry data related to a JID from a scheduler, and network traffic telemetry data related to the JID from a first set of network devices of a network fabric and a second set of network devices of a node; correlating the ML workload telemetry data with network traffic telemetry data using the JID; making, based on the correlating, a determination that there is an issue; inferring that there is a congestion in network traffic, in which, using the JID, the ML workload is identified a cause of the congestion and the first set of network devices is identified not the cause of the congestion; initiating, using a graphical user interface, notifying of a user to: indicate that the ML workload is causing the congestion, and recommend troubleshooting the ML workload for errors.

### BACKGROUND

The training of a machine learning (ML)/artificial intelligence (AI) model involves teaching the model to perform specific tasks by exposing the model to large datasets and iteratively adjusting the model's parameters to minimize errors During training, the model processes input data, makes predictions, and/or compares those predictions to the actual outcomes using, for example, a loss function. Based on the loss, an optimization algorithm (e.g., a gradient descent algorithm) updates the model's parameters to improve the model's accuracy. This process is computationally intensive, particularly for deep learning models with millions or billions of parameters, and may take days or even weeks to complete, depending on the size and complexity of the model and datasets.

### BRIEF DESCRIPTION OF DRAWINGS

Certain embodiments disclosed herein will be described with reference to the accompanying drawings. However, the accompanying drawings illustrate only certain aspects or implementations of one or more embodiments disclosed herein by way of example and are not meant to limit the scope of the claims.

FIG. 1 shows a diagram of a system in accordance with one or more embodiments disclosed herein.

FIG. 2 shows a diagram of an infrastructure node (IN) in accordance with one or more embodiments disclosed herein.

FIGS. 3.1-3.2 show a method for managing performance of an ML workload in accordance with one or more embodiments disclosed herein.

FIG. 4 shows a diagram of a computing device in accordance with one or more embodiments disclosed herein.

### DETAILED DESCRIPTION

Specific embodiments disclosed herein will now be described in detail with reference to the accompanying figures. In the following detailed description of the embodiments disclosed herein, numerous specific details are set forth in order to provide a more thorough understanding of one or more embodiments disclosed herein. However, it will be apparent to one of ordinary skill in the art that the one or more embodiments disclosed herein may be practiced without these specific details. In other instances, well-known features have not been described in detail to avoid unnecessarily complicating the description.

In the following description of the figures, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase “operatively connected” may refer to any direct connection (e.g., wired directly between two devices or components) or indirect connection (e.g., wired and/or wireless connections between any number of devices or components connecting the operatively connected devices). Thus, any path through which information may travel may be considered an operative connection.

As an ML infrastructure is deployed for purposes other than training the next Large Language Model (LLM) (e.g., fine-tuning, inferencing, etc.), the need to simultaneously support multiple users and multiple ML workloads becomes increasingly significant. The current generation of ML Operations (MLOps) frameworks already provide container-based isolation of user applications as well as allocation of hardware computing resources (e.g., full or partial allocation of a graphics processing unit (GPU) to a specific collection of containers), for applications executed on a given IN cluster. By allocating computing resources to a particular ML job/workload, the impact of other jobs (e.g., noisy jobs) can be minimized.

However, the ML workload isolation provided by the MLOps frameworks does not fully extend to GPU-to-GPU collective communications through a related network layer. In other words, traditional approaches cannot distinguish network traffic from (or associated with) a specific ML workload executed on a given set of computing resources (e.g., GPUs, data processing units (DPUs), etc.) from network traffic generated by another ML workload executed simultaneously on a different set of computing resources in an IN(s), or by temporally consecutive ML workloads executed on the same set of computing resources.

For instance, while it may be possible to identify all GPUs used for a specific ML workload, determine their corresponding network interface cards (NICs) (thus corresponding Internet Protocol (IP) addresses), and track network traffic (or network traffic flows) based on source and destination IP addresses, traditional approaches do not scale well for, for example, thousands of GPUs and large network fabrics. As yet another example, traditional approaches do not provide a means to track network traffic from consecutive execution of different ML workloads on the same set of GPUs (thus the same set of IP addresses). As yet another example, traditional approaches do not identify network traffic that has to be sent on a different network rail (e.g., as a result of a link failure), as that would appear to be generated by a different GPU.

Moreover, since network traffic related to ML workloads are not isolated from one another, different ML workloads may be susceptible to noisy neighbor effects from events/issues such as congestion, which makes troubleshooting network performance problems much more complicated. The lack of an ability to identify the network traffic that is associated with a specific ML workload makes some tasks, such as remediating the effects of congestion (in a related network) on a particular high-priority ML workload, impractical.

From a different perspective, the performance (and/or capability) of network fabrics directly impacts the performance of ML workloads, but existing Collective Communications Libraries (CCLs) and MLOps frameworks do not provide straightforward methods to, at least: (a) distinguish network traffic flows from different ML workloads and (b) correlate a given ML workload and the ML workload's collective communications (or collective communication messages) to the ML workload's traffic flows. This makes it difficult to monitor and optimize network traffic flows specific to a given ML workload.

As indicated above, there is no direct approach by which network traffic can be directly associated with ML workloads. While the concept of “partition key” can potentially be used to identify network traffic for a given ML workload, this concept does not extend to non remote direct memory access (RDMA) and related network traffic, thus cannot be used in Ethernet networks for all use cases. In addition, current implementations of CCLs do not use the concept of partition key to label collective communication counters. From a different perspective, while GPU/DPU vendors provide ML workload execution profilers, these profilers are heavy weight (e.g., introduce significant workload overhead), do not provide real-time counters of collective communications messages, and do not provide any job identifier concept (discussed below).

For at least the reasons discussed above and without requiring resource-intensive efforts (e.g., time, engineering, etc.), a fundamentally different approach/framework is needed (e.g., a framework that identifies and segregates the network traffic associated with a specific ML workload(s) and correlate that network traffic to ML workload activities).

Embodiments disclosed herein relate to methods and systems to manage performance of an ML workload. As a result of the processes discussed below, one or more embodiments disclosed herein advantageously ensure that: (i) the framework provides a solution to identify ML workloads, not just network traffic of a particular IN/tenant (where each IN may execute one or more ML workloads within its subnetwork, concomitantly or sequentially, and the framework can distinguish, for example, network traffic (or a network traffic flow) related to ML workload A from network traffic related to ML workload B); (ii) the framework can identify all computing resources (e.g., GPUs) used for a specific ML workload, determine their corresponding NICs or DPUs (and, thus, corresponding IP addresses), and track network traffic flows based on source and destination IP addresses, while scaling well for thousands of computing resources and large network fabrics; (iii) the framework can correlate a given ML workload and the ML workload's collective communications (or collective communication messages) to the ML workload's network traffic flows; (iv) the framework can associate a job identifier (JID) (or an ML JID) with a specific set of network traffic flows; (v) the framework enables communication frameworks (e.g., CCLs) to use low overhead mechanisms to provide detailed, per ML workload “collective communications telemetry data (e.g., ML workload telemetry data) during ML workload execution; and/or (vi) the framework employs a JID (e.g., per workload identifier) to label/tag both network traffic and collective communication messages from specific ML workloads.

The following describes various embodiments disclosed herein.

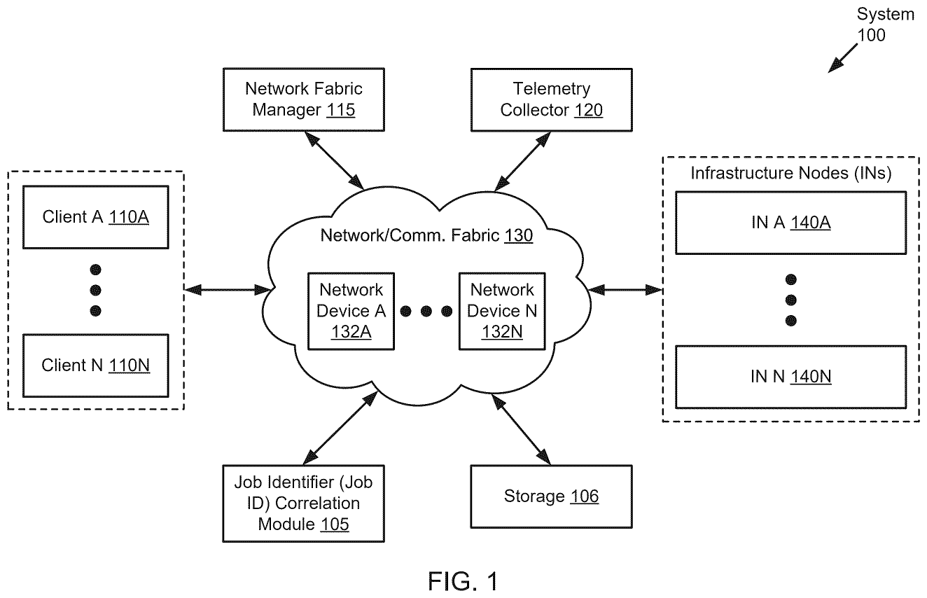

FIG. 1 shows a diagram of a system (100) in accordance with one or more embodiments disclosed herein. The system (100) includes any number of clients (e.g., Client A (110A), Client N (110N), etc.), a storage (106), any number of infrastructure nodes (INs) (e.g., IN A (140A), IN N (140N), etc.), a network fabric manager (115), a telemetry collector (120), a JID correlation module (105), and a network/communication fabric (130). The system (100) may include additional, fewer, and/or different components without departing from the scope of the embodiments disclosed herein. Each component may be operably/operatively connected to any of the other components via any combination of wired and/or wireless connections. Each component illustrated in FIG. 1 is discussed below.

In one or more embodiments, the clients (e.g., 110A, 110N, etc.), the storage (106), the INs (e.g., 140A, 140N, etc.), the network fabric manager (115), the telemetry collector (120), the JID correlation module (105), and the network fabric (130) may be (or may include) physical hardware or logical devices, as discussed below. While FIG. 1 shows a specific configuration of the system (100), other configurations may be used without departing from the scope of the embodiments disclosed herein. For example, although the clients (e.g., 110A, 110N, etc.) and the INs (e.g., 140A, 140N, etc.) are shown to be operatively connected through a communication network (enabled by the network fabric (130)), the clients (e.g., 110A, 110N, etc.) and the INs (e.g., 140A, 140N, etc.) may be directly connected (e.g., without an intervening communication network).

Further, the functioning of the clients (e.g., 110A, 110N, etc.) and the INs (e.g., 140A, 140N, etc.) is not dependent upon the functioning and/or existence of the other components (e.g., devices) in the system (100). Rather, the clients and the INs may function independently and perform operations locally that do not require communication with other components. Accordingly, embodiments disclosed herein should not be limited to the configuration of components shown in FIG. 1.

As used herein, “communication” may refer to simple data passing, or may refer to two or more components coordinating a job. As used herein, the term “data” is intended to be broad in scope. In this manner, that term embraces, for example (but not limited to): a data stream (or stream data), data chunks, data blocks, atomic data, emails, objects of any type, files of any type (e.g., media files, spreadsheet files, database files, etc.), contacts, directories, sub-directories, volumes, etc.

As used herein, a “volume” may be analogous to a logical unit number in a storage area network (SAN), in which a volume may be a subset of the storage's (106) capacity presented by a storage node of the storage as a local block device. A volume's data may be evenly distributed across all storage resources of the storage (106), for example, according to a data layout selected for the storage (106).

In one or more embodiments, although terms such as “document”, “file”, “segment”, “block”, or “object” may be used by way of example, the principles of the present disclosure are not limited to any particular form of representing and storing data or other information. Rather, such principles are equally applicable to any object capable of representing information.

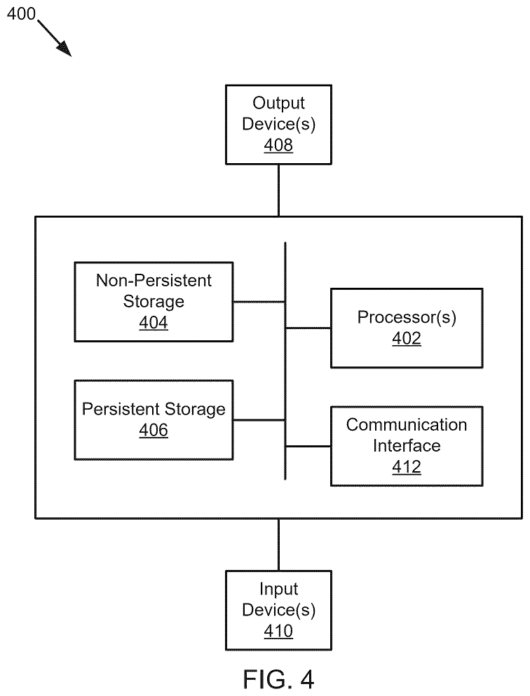

In one or more embodiments, the system (100) may be a distributed system (e.g., a data processing environment) and may deliver at least computing power (e.g., real-time (on the order of milliseconds (ms) or less) network monitoring, server virtualization, data deduplication, etc.), storage capacity (e.g., data backup), and data protection (e.g., software-defined data protection, disaster recovery, etc.) as a service to users (e.g., people, tenants, etc.) of clients (e.g., 110A, 110N, etc.). For example, the system (100) may be configured to organize unbounded, continuously generated data into a data stream. The system (100) may also represent a comprehensive middleware layer executing on computing devices (e.g., 400, FIG. 4) that supports application and storage environments.

In one or more embodiments, the system (100) may support one or more virtual machine (VM) environments, and may map capacity requirements (e.g., computational load, storage access, etc.) of VMs and supported applications to available resources (e.g., processing resources, storage resources, etc.) managed by the environments. Further, the system (100) may be configured for workload placement collaboration and computing resource (e.g., processing, storage/memory, virtualization, networking, etc.) exchange.

To provide computer-implemented services to the users, the system (100) may perform some computations (e.g., data collection, distributed processing of collected data, etc.) locally (e.g., at the users'site using the clients (e.g., 110A, 110N, etc.)) and other computations remotely (e.g., away from the users'site using the INs (e.g., 140A, 140N, etc.)) from the users. By doing so, the users may utilize different computing devices (e.g., 400, FIG. 4) that have different quantities of computing resources (e.g., processing cycles, memory, storage, etc.) while still being afforded consistent user experience. For example, by performing some computations remotely, the system (100) (i) may maintain the consistent user experience provided by different computing devices even when the different computing devices possess different quantities of computing resources, and (ii) may process data more efficiently in a distributed manner by avoiding the overhead associated with data distribution and/or command and control via separate connections.

As used herein, “computing” refers to any operations that may be performed by a computer, including (but not limited to): computation, data storage, data retrieval, communications, etc. Further, as used herein, a “computing device” refers to any device in which a computing operation may be carried out. A computing device may be, for example (but not limited to): a compute component, a storage component, a network device, a telecommunications component, etc.

As used herein, a “resource” refers to any program, application, document, file, asset, executable program file, desktop environment, computing environment, or other resource made available to, for example, a user/customer of a client (described below). The resource may be delivered to the client via, for example (but not limited to): conventional installation, a method for streaming, a VM executing on a remote computing device, execution from a removable storage device connected to the client (such as universal serial bus (USB) device), etc.

In one or more embodiments, a client (e.g., 110A, 110N, etc.) may include functionality to, e.g.,: (i) capture sensory input (e.g., sensor data) in the form of text, audio, video, touch or motion, (ii) collect massive amounts of data at the edge of an Internet of Things (IoT) network (where, the collected data may be grouped as: (a) data that needs no further action and does not need to be stored, (b) data that should be retained for later analysis and/or record keeping, and (c) data that requires an immediate action/response), (iii) provide to other entities (e.g., IN A (140A), the storage (106), etc.), store, or otherwise utilize captured sensor data (and/or any other type and/or quantity of data), (iv) provide surveillance services (e.g., determining object-level information, performing face recognition, etc.) for scenes (e.g., a physical region of space), (v) initiate ML model training and/or ML model inferencing applications on one or more INs (e.g., 140A, 140N, etc.), and/or (vi) monitor the status of the ML model training and/or receive the results of ML model inferencing applications. One of ordinary skill will appreciate that the client may perform other functionalities without departing from the scope of the embodiments disclosed herein.

In one or more embodiments, the clients (e.g., 110A, 110N, etc.) may be geographically distributed devices (e.g., user devices, front-end devices, etc.) and may have relatively restricted hardware and/or software resources when compared to the INs (e.g., 140A, 140N, etc.). As being, for example, a sensing device, each of the clients may be adapted to provide monitoring services. For example, a client may monitor the state of a scene (e.g., objects disposed in a scene). The monitoring may be performed by obtaining sensor data from sensors that are adapted to obtain information regarding the scene, in which a client may include and/or be operatively coupled to one or more sensors (e.g., a physical device adapted to obtain information regarding one or more scenes).

In one or more embodiments, the sensor data may be any quantity and types of measurements (e.g., of a scene's properties, of an environment's properties, etc.) over any period(s) of time and/or at any points-in-time (e.g., any type of information obtained from one or more sensors, in which different portions of the sensor data may be associated with different periods of time (when the corresponding portions of sensor data were obtained)). The sensor data may be obtained using one or more sensors. The sensor may be, for example (but not limited to): a visual sensor (e.g., a camera adapted to obtain optical information (e.g., a pattern of light scattered off of the scene) regarding a scene/environment), an audio sensor (e.g., a microphone adapted to obtain auditory information (e.g., a pattern of sound from the scene) regarding a scene), an electromagnetic radiation sensor (e.g., an infrared sensor), a chemical detection sensor, a temperature sensor, a humidity sensor, a count sensor, a distance sensor, a global positioning system sensor, a biological sensor, a differential pressure sensor, a corrosion sensor, etc.

In one or more embodiments, the clients (e.g., 110A, 110N, etc.) may be physical or logical computing devices configured for hosting one or more workloads, or for providing a computing environment whereon workloads may be implemented. The clients may provide computing environments that are configured for, at least: (i) workload placement collaboration, (ii) computing resource (e.g., processing, storage/memory, virtualization, networking, etc.) exchange, and (iii) protecting workloads (including their applications and application data) of any size and scale (based on, for example, one or more service level agreements (SLAs) configured by users of the clients). The clients (e.g., 110A, 110N, etc.) may correspond to computing devices that one or more users use to interact with one or more components of the system (100).

In one or more embodiments, a client (e.g., 110A, 110N, etc.) may represent a physical appliance or a computing device operated by one or more individuals of (or employed by) an organization. Examples of said individual(s) may include, but not limited to, any organization executive(s) (e.g., chief executive officer (CEO), chief financial officer (CFO), etc.), and any employee(s) in the accounting/finance team of the organization (e.g., a collector person). Further, the organization may refer to any enterprise at least engaged in for-profit commercial, industrial, or professional activities.

In one or more embodiments, a client (e.g., 110A, 110N, etc.) may include any number of applications (and/or content accessible through the applications) that provide computer-implemented services to a user. Applications may be designed and configured to perform one or more functions instantiated by a user of the client. In order to provide application services, each application may host similar or different components. The components may be, for example (but not limited to): instances of databases, instances of email servers, etc. Applications may be executed on one or more clients as instances of the application.

Applications may vary in different embodiments, but in certain embodiments, applications may be custom developed or commercial (e.g., off-the-shelf) applications that a user desires to execute in a client (e.g., 110A, 110N, etc.). In one or more embodiments, applications may be logical entities executed using computing resources of a client. For example, applications may be implemented as computer instructions stored on persistent storage of the client that when executed by the processor(s) of the client, cause the client to provide the functionality of the applications described throughout the application.

In one or more embodiments, while performing, for example, one or more operations requested by a user, applications installed on a client (e.g., 110A, 110N, etc.) may include functionality to request and use physical and logical resources of the client. Applications may also include functionality to use data stored in storage/memory resources of the client. The applications may perform other types of functionalities not listed above without departing from the scope of the embodiments disclosed herein. While providing application services to a user, applications may store data that may be relevant to the user in storage/memory resources of the client.

In one or more embodiments, to provide services to the users, the clients (e.g., 110A, 110N, etc.) may utilize, rely on, or otherwise cooperate with the INs (e.g., 140A, 140N, etc.) and/or the storage (106). For example, the clients may issue requests to IN A (140A) to receive responses and interact with various components of IN A (140A). The clients may also request data from and/or send data to IN A (140A) (for example, the clients may transmit information to IN A that allows IN A to perform computations, the results of which are used by the clients to provide services to the users). As yet another example, the clients may utilize computer-implemented services provided by IN N (140N). When the clients interact with IN N (140N), data that is relevant to the clients may be stored (temporarily or permanently) in IN N.

In one or more embodiments, a client (e.g., 110A, 110N, etc.) may be capable of, e.g.,: (i) collecting users'inputs, (ii) correlating collected users'inputs to the computer-implemented services to be provided to the users, (iii) communicating with the INs (e.g., 140A, 140N, etc.) and/or the storage (106) that perform computations necessary to provide the computer-implemented services, (iv) using the computations performed by, for example, IN A (140A) to provide the computer-implemented services in a manner that appears (to the users) to be performed locally to the users, and/or (v) communicating with any virtual desktop (VD) in a virtual desktop infrastructure (VDI) environment (or a virtualized architecture) provided by the INs (using any known protocol in the art), for example, to exchange remote desktop traffic or any other regular protocol traffic (so that, once authenticated, users may remotely access independent VDs).

As described above, the clients (e.g., 110A, 110N, etc.) may provide computer-implemented services to users (and/or other computing devices). The clients may provide any number and any type of computer-implemented services. To provide computer-implemented services, each client may include a collection of physical components (e.g., processing resources, storage/memory resources, networking resources, etc.) configured to perform operations of the client and/or otherwise execute a collection of logical components (e.g., virtualization resources) of the client.

In one or more embodiments, a processing resource (not shown) may refer to a measurable quantity of a processing-relevant resource type, which can be requested, allocated, and consumed. A processing-relevant resource type may encompass a physical device (i.e., hardware), a logical intelligence (i.e., software), or a combination thereof, which may provide processing or computing functionality and/or services. Examples of a processing-relevant resource type may include (but not limited to): a central processing unit (CPU), a GPU, a DPU, a computation acceleration resource, an application-specific integrated circuit (ASIC), a digital signal processor for facilitating high speed communication, etc.

In one or more embodiments, a storage or memory resource (not shown) may refer to a measurable quantity of a storage/memory-relevant resource type, which can be requested, allocated, and consumed (for example, to store sensor data and provide previously stored data). A storage/memory-relevant resource type may encompass a physical device, a logical intelligence, or a combination thereof, which may provide temporary or permanent data storage functionality and/or services. Examples of a storage/memory-relevant resource type may be (but not limited to): a hard disk drive (HDD), a solid-state drive (SSD), random access memory (RAM), Flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, virtualized memory, etc.

In one or more embodiments, while the clients (e.g., 110A, 110N, etc.) provide computer-implemented services to users, the clients may store data that may be relevant to the users to the storage/memory resources. When the user-relevant data is stored (temporarily or permanently), the user-relevant data may be subjected to loss, inaccessibility, or other undesirable characteristics based on the operation of the storage/memory resources.

To mitigate, limit, and/or prevent such undesirable characteristics, users of the clients (e.g., 110A, 110N, etc.) may enter into agreements (e.g., SLAs) with providers (e.g., vendors) of the storage/memory resources. These agreements may limit the potential exposure of user-relevant data to undesirable characteristics. These agreements may, for example, require duplication of the user-relevant data to other locations so that if the storage/memory resources fail, another copy (or other data structure usable to recover the data on the storage/memory resources) of the user-relevant data may be obtained. These agreements may specify other types of activities to be performed with respect to the storage/memory resources without departing from the scope of the embodiments disclosed herein.

In one or more embodiments, a networking resource (not shown) may refer to a measurable quantity of a networking-relevant resource type, which can be requested, allocated, and consumed. A networking-relevant resource type may encompass a physical device, a logical intelligence, or a combination thereof, which may provide network connectivity functionality and/or services. Examples of a networking-relevant resource type may include (but not limited to): a NIC, a network adapter, a network processor, etc.

In one or more embodiments, a networking resource may provide capabilities to interface a client with external entities (e.g., IN A (140A), the storage (106), etc.) and to allow for the transmission and receipt of data with those entities. A networking resource may communicate via any suitable form of wired interface (e.g., Ethernet, fiber optic, serial communication etc.) and/or wireless interface, and may utilize one or more protocols (e.g., transport control protocol (TCP), user datagram protocol (UDP), RDMA, RDMA over Converged Ethernet (RoCE), IEEE 801.11, etc.) for the transmission and receipt of data.

In one or more embodiments, a networking resource may implement and/or support the above-mentioned protocols to enable the communication between the client and the external entities. For example, a networking resource may enable the client to be operatively connected, via Ethernet, using a TCP protocol to form a “network fabric”, and may enable the communication of data between the client and the external entities. In one or more embodiments, each client may be given a unique identifier (e.g., an IP address) to be used when utilizing the above-mentioned protocols.

Further, a networking resource, when using a certain protocol or a variant thereof, may support streamlined access to storage/memory media of other clients (e.g., 110A, 110N, etc.). For example, when utilizing Remote DMA (“RDMA”), e.g., RoCE to access data on another client, it may not be necessary to interact with the logical components of that client. Rather, when using RDMA, it may be possible for the networking resource to interact with the physical components of that client to retrieve and/or transmit data, thereby avoiding any higher-level processing by the logical components executing on that client.

In one or more embodiments, a virtualization resource (not shown) may refer to a measurable quantity of a virtualization-relevant resource type (e.g., a virtual hardware component), which can be requested, allocated, and consumed, as a replacement for a physical hardware component. A virtualization-relevant resource type may encompass a physical device, a logical intelligence, or a combination thereof, which may provide computing abstraction functionality and/or services. Examples of a virtualization-relevant resource type may include (but not limited to): a virtual server, a VM, a container, a virtual CPU (vCPU), a virtual storage pool, etc.

In one or more embodiments, a virtualization resource may include a hypervisor (e.g., a VM monitor), in which the hypervisor may be configured to orchestrate an operation of, for example, a VM by allocating computing resources of a client (e.g., 110A, 110N, etc.) to the VM. In one or more embodiments, the hypervisor may be a physical device including circuitry. The physical device may be, for example (but not limited to): a field-programmable gate array (FPGA), an application-specific integrated circuit, a programmable processor, a microcontroller, a digital signal processor, etc. The physical device may be adapted to provide the functionality of the hypervisor. Alternatively, in one or more of embodiments, the hypervisor may be implemented as computer instructions stored on storage/memory resources of the client that when executed by processing resources of the client, cause the client to provide the functionality of the hypervisor.

In one or more embodiments, a client (e.g., 110A, 110N, etc.) may be, for example (but not limited to): a physical computing device, a smartphone, a tablet, a wearable, a gadget, a closed-circuit television (CCTV) camera, a music player, a game controller, etc. Different clients may have different computational capabilities. In one or more embodiments, Client A (110A) may have 16 gigabytes (GB) of dynamic RAM (DRAM) and 1 CPU with 12 cores, whereas Client N (110N) may have 8 GB of PMEM and 1 CPU with 16 cores. Other different computational capabilities of the clients not listed above may also be considered without departing from the scope of the embodiments disclosed herein.

Further, in one or more embodiments, a client (e.g., 110A, 110N, etc.) may be implemented as a computing device (e.g., 400, FIG. 4). The computing device may be, for example, a desktop computer, a server, a distributed computing system, or a cloud resource. The computing device may include one or more processors, memory (e.g., RAM), GPUs, Neural Processing Units (“NPUs”), Tensor Processing Units (“TPUs”) and persistent storage (e.g., HDDs, SSDs, etc.). The computing device may include instructions, stored in the persistent storage, that when executed by the processor(s) of the computing device cause the computing device to perform the functionality of the client described throughout the application.

Alternatively, in one or more embodiments, the client (e.g., 110A, 110N, etc.) may be implemented as a logical device (e.g., a VM). The logical device may utilize the computing resources of any number of computing devices to provide the functionality of the client described throughout this application.

In one or more embodiments, users (e.g., administrators, organization executives, etc.) may interact with (or operate) the clients (e.g., 110A, 110N, etc.) in order to perform work-related tasks (e.g., production workloads). In one or more embodiments, the accessibility of users to the clients may depend on a regulation set by an administrator of the clients. To this end, each user may have a personalized user account that may, for example, grant access to certain data, applications, and computing resources of the clients. This may be realized by implementing virtualization technology. In one or more embodiments, an administrator may be a user with permission (e.g., a user that has root-level access) to make changes to the clients that will affect other users of the clients.

In one or more embodiments, for example, a user may be automatically directed to a login screen of a client when the user connected to that client. Once the login screen of the client is displayed, the user may enter credentials (e.g., username, password, etc.) of the user on the login screen. The login screen may be a graphical user interface (GUI) generated by a visualization module (not shown) of the client. In one or more embodiments, the visualization module may be implemented in hardware (e.g., circuitry), software, or any combination thereof.

In one or more embodiments, a GUI may be displayed on a display of a computing device (e.g., 400, FIG. 4) using functionalities of a display engine (not shown), in which the display engine is operatively connected to the computing device. The display engine may be implemented using hardware (or a hardware component), software (or a software component), or any combination thereof. The login screen may be displayed in any visual format that would allow the user to easily comprehend (e.g., read and parse) the listed information.

In one or more embodiments, an IN of the INs (e.g., 140A, 140N, etc.) may include (i) a chassis (e.g., a mechanical structure, a rack mountable enclosure, etc.) configured to house one or more servers (or blades) and their components and (ii) any instrumentality or aggregate of instrumentalities operable to compute, classify, process, transmit, receive, retrieve, originate, switch, store, display, manifest, detect, record, reproduce, handle, and/or utilize any form of data for business, management, entertainment, or other purposes.

In one or more embodiments, an IN of the INs (e.g., 140A, 140N, etc.) may include functionality to, e.g.,: (i) obtain (or receive) data (e.g., any type and/or quantity of input) from any source (and, if necessary, aggregate the data); (ii) perform complex analytics and analyze data that is received from one or more clients (e.g., 110A, 110N, etc.) to generate additional data that is derived from the obtained data without experiencing any middleware and hardware limitations; (iii) provide meaningful information (e.g., a response) back to the corresponding clients; (iv) filter data (e.g., received from a client) before pushing the data (and/or the derived data) to the storage for management of the data and/or for storage of the data (while pushing the data, the IN may include information regarding a source of the data (e.g., an identifier of the source) so that such information may be used to associate provided data with one or more of the users (or data owners)); (v) host and maintain various workloads; (vi) provide a computing environment whereon workloads may be implemented (e.g., employing linear, non-linear, and/or ML models to perform cloud-based data processing); (vii) incorporate strategies (e.g., strategies to provide VDI capabilities) for remotely enhancing capabilities of the clients; (viii) provide robust security features to the clients and make sure that a minimum level of service is always provided to a user of a client; (ix) transmit the result(s) of the computing work performed (e.g., real-time business insights, equipment maintenance predictions, other actionable responses, etc.) to another IN for review and/or other human interactions; (x) exchange data with other devices registered in/to the network fabric (130) in order to, for example, participate in a collaborative workload placement (e.g., the node may split up a request (e.g., an operation, a task, an activity, etc.) with another IN, coordinating its efforts to complete the request more efficiently than if the IN had been responsible for completing the request); (xi) provide software-defined data protection for the clients (e.g., 110A, 110N, etc.); (xii) provide automated data discovery, protection, management, and recovery operations for the clients; (xiii) monitor operational states of the clients; (xiv) regularly back up configuration information of the clients to the storage (106); (xv) provide (e.g., via a broadcast, multicast, or unicast mechanism) information (e.g., a location identifier, the amount of available resources, etc.) associated with the IN to other INs of the system (100); (xvi) configure or control any mechanism that defines when, how, and what data to provide to the clients and/or to the storage; (xvii) provide data deduplication to the clients; (xviii) orchestrate data protection through one or more GUIs; (xix) empower data owners (e.g., users of the clients) to perform self-service data backup and restore operations from their native applications; (xx) ensure compliance and satisfy different types of service level objectives (SLOs) set by an administrator/user; (xxi) increase resiliency of an organization by enabling rapid recovery or cloud disaster recovery from cyber incidents; (xxii) provide operational simplicity, agility, and flexibility for physical, virtual, and cloud-native environments; (xxiii) consolidate multiple data process or protection requests (received from, for example, clients) so that duplicative operations (which may not be useful for restoration purposes) are not generated; (xxiv) initiate multiple data process or protection operations in parallel (e.g., an IN may host multiple operations, in which each of the multiple operations may (a) manage the initiation of a respective operation and (b) operate concurrently to initiate multiple operations); and/or (xxv) manage operations of one or more clients (e.g., receiving information from the clients regarding changes in the operation of the clients) to improve their operations (e.g., improve the quality of data being generated, decrease the computing resources cost of generating data, etc.). In one or more embodiments, in order to read, write, or store data, the IN (e.g., 140A, 140N, etc.) may communicate with, for example, the storage (106) and/or other storage devices in the system (100).

Further, an IN of the INs (e.g., 140A, 140N, etc.) may include functionality to execute one or more ML workloads (e.g., ML (or ML model) training workloads, ML inferencing workloads, etc.). Each IN may include a local ML application (not shown) that manages the execution of various ML workloads on, for example, GPUs and/or DPUs of that IN. In one or more embodiments, the INs (e.g., 140A, 140N, etc.) may be operatively connected to each other via a top-of-rack switch when the INs/servers are in the same IN rack, or via a scale-out network (enabled by the network fabric (130)) when the INs are in different IN racks and/or in different geographic locations/zones across the world.

As indicated above, each IN (e.g., 140A, 140N, etc.) may include a set of GPUs, DPUs, and/or NICs (e.g., to execute multiple ML workloads that use same network connections on the network fabric (130)). In one or more embodiments, the set of DPUs may be operatively connected to the set of GPUs via a peripheral component interconnect express (PCIe) fabric. The PCIe fabric is a high-speed, point-to-point interconnect architecture that allows the set of GPUs and the set of DPUs (as well as other hardware components (not shown) in that IN) to communicate directly with each other using the PCIe protocol and one or more PCIe switches. Further, the set of DPUs and the set of GPUs may communicate and/or transmit data to each other via the PCIe fabric using PCIe interfaces located on each DPU and GPU. Some embodiments may include PCIe switches between the DPUs/NICs and GPUs. In another embodiment, a Compute Express Link (CXL) bus, or other interconnect technologies, may be used to connect a GPU and associated DPU(s). In one or more embodiments, each IN (e.g., 140A, 140N, etc.) may also include other hardware components/resources such as, for example, processors, volatile storage (e.g., memory), non-volatile storage (e.g., HDDs, SSDs, etc.), etc.

As used herein, a GPU is a specialized electronic component that includes multiple cores (also referred to as GPU cores) arranged to enable high-performance parallel computing tasks. A GPU also includes large amounts of volatile memory (e.g., memory sufficient to store 80 GB of data) to support the parallel processing of the multiple GPU cores. A GPU may provide/implement additional functionalities without departing from the scope of the embodiments disclosed herein.

As used herein, a DPU is a specialized electronic component that includes one or more network interfaces and is designed to offload various networking tasks (e.g., packet processing, encryption, data compression, network virtualization, etc.) from a corresponding IN's CPU (not shown). A DPU may include local volatile storage in the form of a cache (not shown). Those skilled in the art will appreciate that the cache may be implemented using any other form of volatile and/or non-volatile storage (e.g., RAM, Flash memory, magnetic memory, etc.) without departing from the scope of the embodiments disclosed herein.

Further, in an IN (e.g., 140A, 140N, etc.), each DPU may be mapped 1:1 to a GPU. For example, GPU A may be mapped to DPU T. Once mapped, the cache of DPU T may be used to store checkpoint data from GPU A as well as data that is to be used by GPU A for ML model training and/or ML inferencing. A DPU may provide additional functionalities without departing from the scope of the embodiments disclosed herein.

As discussed above, DPUs in an IN (e.g., 140A, 140N, etc.) may include caches. These caches may be sized such that they can temporarily store checkpoint data generated by GPUs in the IN. In this manner, a GPU may only be paused for the time the GPU takes to obtain the checkpoint data and then transmit the checkpoint data to a related DPU (which may be mapped 1:1 or 1:N to the GPU) via a PCIe fabric. Once the checkpoint data has been stored in the cache, the GPU can resume execution of, for example, the ML workload. By locally storing the checkpoint data in the cache, the GPU can resume operation prior the checkpoint data being stored in the storage (106).

As described above, an IN (e.g., 140A, 140N, etc.) may be capable of providing a range of functionalities/services to the users of the clients (e.g., 110A, 110N, etc.). However, not all users may be allowed to receive all the services. To manage the services provided to the users of the clients, the network fabric manager (115) in accordance with embodiments disclosed herein may manage the operation of the network fabric (130) and the network enabled by the network fabric, in which the clients are operably connected to the INs over the network. Specifically, the network fabric manager (115) (i) may identify services to be provided by the INs (for example, based on the number of users using the clients) and (ii) may limit communications of the clients to receive IN provided services.

For example, the priority (e.g., the user access level) of a user may be used to determine how to manage computing resources of IN A (140A) to provide services to that user. As yet another example, the priority of a user may be used to identify the services that need to be provided to that user. As yet another example, the priority of a user may be used to determine how quickly communications (for the purposes of providing services in cooperation with the internal network (and its subcomponents)) are to be processed by the internal network.

Further, consider a scenario where a first user is to be treated as a normal user (e.g. a non-privileged user, a user with a user access level/tier of 4/10). In such a scenario, the user level of that user may indicate that certain ports (of the subcomponents of the network corresponding to communication protocols such as the TCP, the UDP, etc.) are to be opened, other ports are to be blocked/disabled so that (i) certain services are to be provided to the user by IN N (140N) (e.g., while the computing resources of IN N may be capable of providing/performing any number of remote computer-implemented services, they may be limited in providing some of the services over the network enabled/provided by the network fabric (130)) and (ii) network traffic from that user is to be afforded a normal level of quality (e.g., a normal processing rate with a limited communication bandwidth (BW)). By doing so, (i) computer-implemented services provided to the users of the clients (e.g., 110A, 110N, etc.) may be granularly configured without modifying the operation(s) of the clients and (ii) the overhead for managing the services of the clients may be reduced by not requiring modification of the operation(s) of the clients directly.

In contrast, a second user may be determined to be a high priority user (e.g., a privileged user, a user with a user access level of 9/10). In such a case, the user level of that user may indicate that more ports are to be opened than were for the first user so that (i) IN A (140A) may provide more services to the second user and (ii) network traffic from that user is to be afforded a high-level of quality (e.g., a higher processing rate than the traffic from the normal user).

As used herein, a “workload” is a physical or logical component configured to perform certain work functions. Workloads may be instantiated and operated while consuming computing resources allocated thereto. A user may configure a data protection policy for various workload types. Examples of a workload may include (but not limited to): a data protection workload, a VM, a container, a network-attached storage (NAS), a database, an application, a collection of microservices, a file system (FS), small workloads with lower priority workloads (e.g., FS host data, operating system (OS) data, etc.), medium workloads with higher priority (e.g., VM with FS data, network data management protocol (NDMP) data, etc.), large workloads with critical priority (e.g., mission critical application data), etc.

As used herein, a “policy” is a collection of information, such as a backup policy or other data protection policy, that includes, for example (but not limited to): identity of source data that is to be protected, backup schedule and retention requirements for backed up source data, identity of an SLA (or a rule) that applies to source data, identity of a target device where source data is to be stored, etc.

As used herein, the term “backup” is intended to be broad in scope. In this manner, example backups (in connection with which embodiments disclosed herein) may be employed include (but not limited to): full backups, partial backups, clones, snapshots, incremental backups, differential backups, etc.

As used herein, “data retention” is a period of time, with a definite start and end, within which the data should be retained in storage/database (e.g., 106). For example, a set of user requirements and/or technical considerations (e.g., security considerations, performance considerations, etc.) of a data center may be used to generate a data retention policy specifying that user data should be retained in the database for seven years.

As used herein, a “rule” is a guideline used by an SLA component to select a particular target device (or target devices), based on the ability of the target device to meet requirements imposed by the SLA. For example, a rule may specify that an HDD having a particular performance parameter should be used as the target device. A target device selected by the SLA component may be identified as part of a backup policy or other data protection policy.

Further, while a single IN (e.g., 140A) is considered above, the term “node” includes any collection of systems or sub-systems that individually or jointly execute a set, or multiple sets, of instructions to provide one or more computer-implemented services. For example, a single IN/server/host may provide a computer-implemented service on its own (i.e., independently) while multiple other nodes may provide a second computer-implemented service cooperatively (e.g., each of the multiple other nodes may provide similar and or different services that form the cooperatively provided service).

As described above, an IN (e.g., 140A) may provide any quantity and any type of computer-implemented services. To provide computer-implemented services, the IN may be a heterogeneous set, including a collection of physical components/resources (discussed above) configured to perform operations of the node and/or otherwise execute a collection of logical components/resources (discussed above) of the node.

In one or more embodiments, an IN (e.g., 140A, 140N, etc.) may implement a management model to manage the aforementioned computing resources in a particular manner. The management model may give rise to additional functionalities for the computing resources. For example, the management model may automatically store multiple copies of data in multiple locations when a single write of the data is received. By doing so, a loss of a single copy of the data may not result in a complete loss of the data. Other management models may include, for example, adding additional information to stored data to improve its ability to be recovered, methods of communicating with other devices to improve the likelihood of receiving the communications, etc. Any type and number of management models may be implemented to provide additional functionalities using the computing resources without departing from the scope of the embodiments disclosed herein.

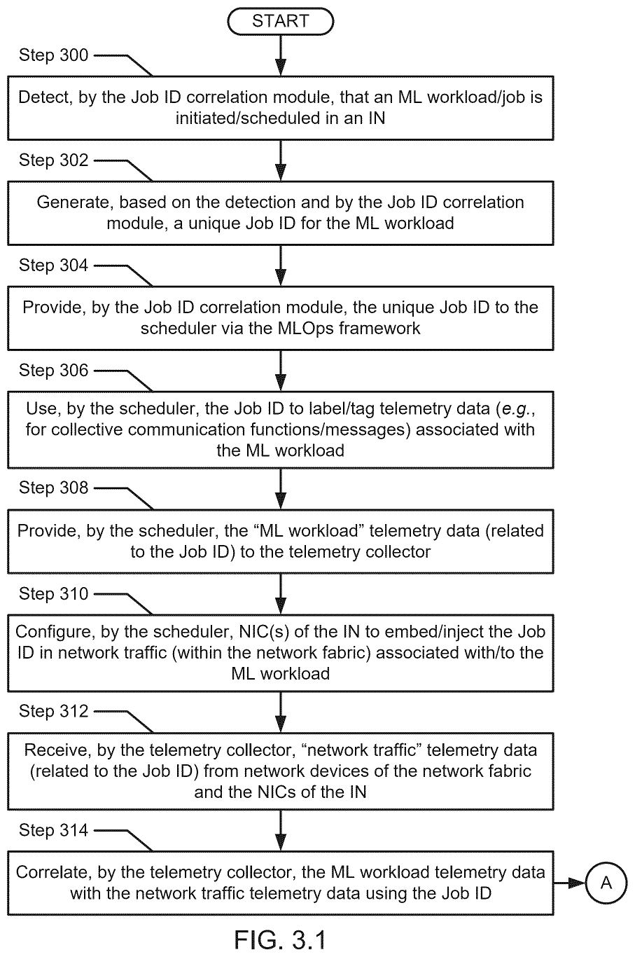

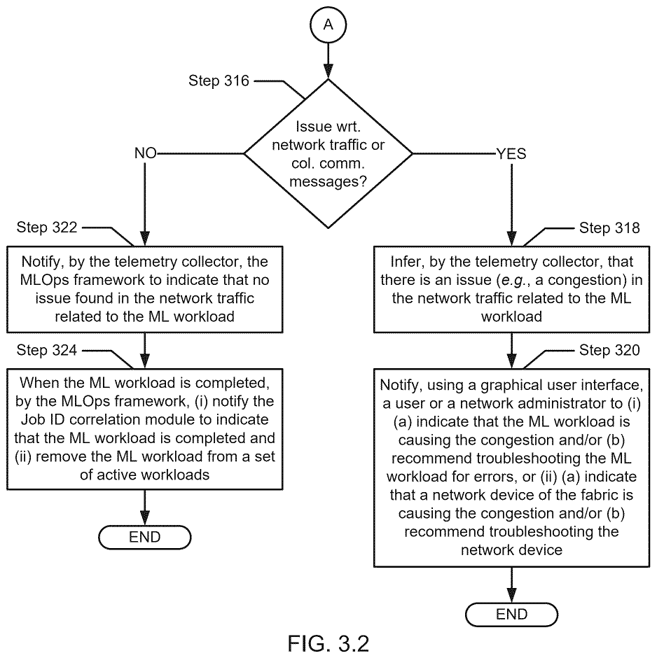

One of ordinary skill will appreciate that an IN (e.g., 140A, 140N, etc.) may perform other functionalities without departing from the scope of the embodiments disclosed herein. In one or more embodiments, an IN (e.g., 140A, 140N, etc.) may be configured to perform all, or a portion, of the functionalities described in FIGS. 3.1-3.2.

In one or more embodiments, an IN (e.g., 140A, 140N, etc.) may be implemented as a computing device (e.g., 400, FIG. 4). The computing device may be, for example, a mobile phone, a tablet computer, a laptop computer, a desktop computer, a server, a distributed computing system, or a cloud resource. The computing device may include one or more processors, memory (e.g., RAM), GPUs, NPUs, TPUs, and persistent storage (e.g., HDDs, SSDs, etc.). The computing device may include instructions, stored in the persistent storage, that when executed by the processor(s) of the computing device cause the computing device to perform the functionality of the IN described throughout the application.

Alternatively, in one or more embodiments, similar to a client (e.g., 110A, 110N, etc.), the IN may also be implemented as a logical device.

One of ordinary skill will appreciate that the network fabric manager (115) may perform other functionalities (e.g., setting up the network fabric (130) with parameters corresponding to a related JID) without departing from the scope of the embodiments disclosed herein. In one or more embodiments, the network fabric manager (115) may be configured to perform all, or a portion, of the functionalities described in FIGS. 3.1-3.2.

In one or more embodiments, the network fabric manager (115) may be implemented as a computing device (e.g., 400, FIG. 4). The computing device may be, for example, a mobile phone, a tablet computer, a laptop computer, a desktop computer, a server, a distributed computing system, or a cloud resource. The computing device may include one or more processors, memory (e.g., RAM), GPUs, NPUs, TPUs, and persistent storage (e.g., HDDs, SSDs, etc.). The computing device may include instructions, stored in the persistent storage, that when executed by the processor(s) of the computing device cause the computing device to perform the functionality of the network fabric manager (115) described throughout the application.

Alternatively, in one or more embodiments, similar to a client (e.g., 110A, 110N, etc.), the network fabric manager (115) may also be implemented as a logical device.

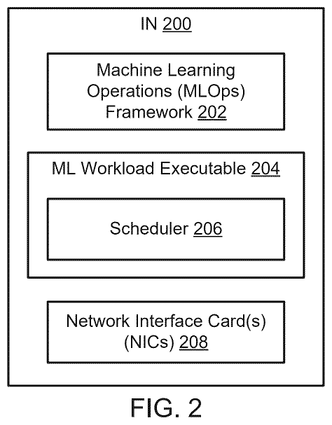

In one or more embodiments, an IN (e.g., 140A, 140N, etc.) may host, at least, an MLOps framework (e.g., 202, FIG. 2), an ML workload executable (e.g., 204, FIG. 2), and a set of NICs (e.g., 208, FIG. 2). The MLOps framework, the ML workload executable, and the NICs may be physical or logical computing devices/entities. Additional details of the MLOps framework, the ML workload executable, and the NICs are described below in reference to FIG. 2.

In the embodiments of the present disclosure, the storage (106) is demonstrated as a separate entity from an IN (e.g., 140A, 140N, etc.); however, embodiments disclosed herein are not limited as such. The storage (106) may be demonstrated as a part of an IN (e.g., as deployed to the IN).

Turning now to the storage (106), the storage (106) may provide long-term, durable, high read/write throughput data storage/protection with near-infinite scale and low-cost. The storage (106) may be a fully managed cloud/remote (or local) storage (e.g., pluggable storage, object storage, block storage, file system storage, data stream storage, Web servers, unstructured storage, etc.) that acts as a shared storage/memory resource that is functional to store unstructured and/or structured data. For example, the storage (106) may store data (e.g., backup data; file system metadata; assets; rules and/or procedures for performing backups of the INs; etc.). Further, the storage (106) may also occupy a portion of a physical storage/memory device or, alternatively, may span across multiple physical storage/memory devices. The storage (106) may include other and/or additional functionalities without departing from embodiments disclosed herein.

In one or more embodiments, the storage (106) may be implemented using physical devices that provide data storage services (e.g., storing data and providing copies of previously stored data). The devices that provide data storage services may include hardware devices and/or logical devices. For example, the storage (106) may include any quantity and/or combination of memory devices (i.e., volatile storage), long-term storage devices (i.e., persistent storage), other types of hardware devices that may provide short-term and/or long-term data storage services, and/or logical storage devices (e.g., virtual persistent storage/virtual volatile storage).

For example, the storage (106) may include a memory device (e.g., a dual in-line memory device), in which data is stored and from which copies of previously stored data are provided. As yet another example, the storage (106) may include a persistent storage device (e.g., an SSD), in which data is stored and from which copies of previously stored data is provided. As yet another example, the storage (106) may include (i) a memory device in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data).

Further, the storage (106) may also be implemented using logical storage. Logical storage (e.g., virtual disk) may be implemented using one or more physical storage devices whose storage resources (all, or a portion) are allocated for use using a software layer. Thus, logical storage may include both physical storage devices and an entity executing on a processor or another hardware device that allocates storage resources of the physical storage devices.

In one or more embodiments, the storage (106) may store/log/record unstructured and/or structured data that may include (or specify), for example (but not limited to): a backup policy/practice; telemetry data including past and present device usage of one or more computing devices; data for execution of applications/services including IN applications and associated end-points; corpuses of annotated data used to build/generate and train processing classifiers for trained ML models; linear, non-linear, and/or ML model parameters; data tags; an identifier of a sensor; a product identifier of a client (e.g., 110A); a type of a client; historical sensor data/input (e.g., visual sensor data, audio sensor data, electromagnetic radiation sensor data, temperature sensor data, humidity sensor data, corrosion sensor data, etc., in the form of text, audio, video, touch, and/or motion) and its corresponding details; an identifier of a data item; a size of the data item; an identifier of a user (e.g., a unique string or combination of bits associated with a particular user) who initiated a backup (via a client); a distributed model identifier that uniquely identifies a distributed model; a user activity performed on a data item; a cumulative history of user/administrator activity records obtained over a prolonged period of time; a setting (and a version) of a mission critical application executing on an IN (e.g., 140A); configuration information associated with an IN (e.g., 140A); a job detail of a job that has been initiated by an IN (e.g., 140A); a type of the job (e.g., a non-parallel processing job, a parallel processing job, an analytics job, etc.); information associated with a hardware resource set (discussed below) of an IN (e.g., 140A); a completion timestamp encoding a date and/or time reflective of the successful completion of a job; a time duration reflecting the length of time expended for executing and completing a job; a backup retention period associated with an asset (e.g., data item); a status of a job (e.g., how many jobs are still active, how many jobs are completed, etc.); a number of requests handled (in parallel) per minute (or per second, per hour, etc.) by an IN (e.g., 140A); a number of errors encountered when handling a job (e.g., a backup process); a documentation that shows how IN (e.g., 140A) performs against an SLO and/or an SLA; a set of requests received by an IN (e.g., 140A); a set of responses provided (by the IN) to those requests; information regarding an administrator (e.g., a high priority trusted administrator, a low priority trusted administrator, etc.) related to a job; tier/level information of a user (e.g., a high-privileged user, a low-privileged user, etc.); a geographic location (e.g., a country) associated with the user; a timestamp showing when a specific request is processed an IN (e.g., 140A); computing resource details (including details of hardware components and/or software components) and an IP address of an IN (e.g., 140A) hosting an application where a specific request is processed; information with respect to historical metadata (e.g., system logs, applications logs, telemetry data including past and present device usage of one or more computing devices in the system (100), etc.); computing resource details and an IP address of a client that sent a specific request (e.g., to an IN); an existing knowledge base (KB) article; a technical support history documentation of a customer/user; a port's user guide; a port's release note; a community forum question and its associated answer; a catalog file of an application upgrade; details of a compatible OS version for an application upgrade to be installed; an application upgrade sequence; a solution or a workaround document for a software failure; one or more lists that specify which computer-implemented services should be provided to which user (depending on a user access level of a user); a fraud report for an invalid user; a set of SLAs (e.g., an agreement that indicates a period of time required to retain a profile of a user); information with respect to a user/customer experience; checkpoint data; data used for ML model training and/or ML inferencing; etc.

In one or more embodiments, information associated with a hardware resource set (e.g., including at least resource related parameters) may specify, for example (but not limited to): a configurable CPU option (e.g., a valid/legitimate vCPU count for an IN (e.g., 140A)), a configurable network resource option (e.g., enabling/disabling single-root input/output virtualization (SR-IOV) for the IN), a configurable memory option (e.g., maximum and minimum memory for the IN), a configurable GPU option (e.g., allowable scheduling policy and/or virtual GPU (vGPU) count combinations for the IN), a configurable DPU option (e.g., legitimacy of disabling inter-integrated circuit (I2C) for the IN), a configurable storage space option (e.g., a list of disk cloning technologies across one or more INs in the system (100)), a configurable storage I/O option (e.g., a list of possible file system block sizes across all target file systems), a user type (e.g., a knowledge worker, a task worker with relatively low-end compute requirements, a high-end user that requires a rich multimedia experience, etc.), a network resource related template (e.g., a 10 GB/s BW with 20 ms latency quality of service (QoS) template), a DPU related template (e.g., a 1 GB/s BW vDPU with 1 GB vDPU frame buffer template), a GPU related template (e.g., a depth-first vGPU with 1 GB vGPU frame buffer template), a storage space related template (e.g., a 40 GB SSD storage template), a CPU related template (e.g., a 1 vCPU with 4 cores template), a memory resource related template (e.g., an 8 GB DRAM template), a vCPU count per analytics engine, a virtual NIC (vNIC) count per IN in the system (100), a wake on LAN support configuration (e.g., supported/enabled, not supported/disabled, etc.), a vGPU count per IN in the system (100), a type of a vGPU scheduling policy (e.g., a “fixed share” vGPU scheduling policy), a storage mode configuration (e.g., an enabled high-performance storage array mode), etc.

While the storage (106) has been illustrated and described as including a limited number and type of data, the storage (106) may store additional, less, and/or different data without departing from the scope of the embodiments disclosed herein. One of ordinary skill will appreciate that the storage (106) may perform other functionalities without departing from the scope of the embodiments disclosed herein.

In one or more embodiments, as being a physical computing device or a logical computing device, the Job ID (or JID) correlation module (105) may include functionality to, at least: (i) detect that an ML workload is initiated/scheduled in an IN (e.g., 140A, 140N, etc.), in which (a) the ML workload is initiated upon receiving a request from a user of a client (e.g., 110A, 110N, etc.) and (b) upon receiving a workload initiation request (which is generated based on the user's request) associated with the ML workload from the MLOps framework (e.g., 202, FIG. 2), the JID correlation module detects that the ML workload is initiated in the IN; (ii) upon detecting that the ML workload is initiated in the IN, generate a unique JID for the ML workload (e.g., a unique string or combination of bits associated with the ML workload); (iii) provide the unique JID to a scheduler (e.g., 206, FIG. 2) via the MLOps framework (where the scheduler may be a CCL); and/or (iv) enable the telemetry collector (120) to correlate ML workload telemetry data (including, at least, collective communication messages generated by the execution of the ML workload) with network traffic telemetry data (generated by network devices (e.g., Network Device A (132A), Network Device N (132N), etc.) of the network fabric (130) for the ML workload (or for the ML workload's network traffic)).

One of ordinary skill will appreciate that the JID correlation module (105) may perform other functionalities without departing from the scope of the embodiments disclosed herein. In one or more embodiments, the JID correlation module (105) may be configured to perform all, or a portion, of the functionalities described in FIGS. 3.1-3.2.

In the embodiments of the present disclosure, the JID correlation module (105) is demonstrated as a separate entity from an IN (e.g., 140A, 140N, etc.); however, embodiments disclosed herein are not limited as such. The JID correlation module (105) may be demonstrated as a part of an IN (e.g., as deployed to the IN) or co-located with the IN in the same environment.

In one or more embodiments, the system (100) enables a mechanism to tag/label data packets on the network fabric (130) with a unique JID and use the same JID to collect (and label) collective communication counters (indicating, for example, the number of collective communication messages sent among a set of GPUs, which causes network traffic) for each ML workload. In this manner, usage of a JID enables: (a) fine-grained observability and monitoring of network traffic related to ML workloads (where, for each ML workload, the telemetry collector (120) may infer how each collective communication function (e.g., an “all reduce” function, an “all gather” function, a broadcast function, etc.) and other activities (e.g., checkpointing, data loading, etc.) that generate network traffic on the network enabled by the network fabric (130) (more specifically, the network enabled by the network devices (e.g., 132A, 132N, etc.)), (b) operators (e.g., network administrators) to classify network traffic (where classification categories may include attributes related to the type of ML workload (e.g., a training workload, a fine-tuning workload, an inference workload, etc.) and the relative importance/priority of the workload (e.g., a high-priority ML workload, a low-priority ML workload, etc.)), and (c) performance of enhanced operations (where network traffic can be prioritized and scheduled on a per-ML workload basis, in order to limit noisy-neighbor side effects (e.g., effects of other ML workloads that are being executed) and ensure that high-priority ML workloads are not impacted by low-priority ML workloads). Further, a unique JID may be allocated to (by the JID correlation module (105) or the MLOps framework (e.g., 202, FIG. 2)) a related ML workload when the ML workload is initiated, in which the JID may provide a reference by which individual data packets/flow(s) on the network (enabled by the network fabric (130)) may be correlated to a specific ML workload.

As used herein, a collective communication function refers to a collective communication operation that allows, for example, collecting data from different processing units (e.g., GPUs, DPUs, etc.) to combine the data into a global/aggregated result. In turn, the result may be distributed back to all the processing units.

In one or more embodiments, the JID correlation module (105) may provide a mechanism (e.g., to the telemetry collector (120)) that helps associating workload/job related information to specific network traffic flows and workload activities (e.g., collective communication functions). Such information (e.g., ML workload telemetry data) may include, for example (but not limited to): a unique JID of an ML workload, a name of the ML workload, an owner of the ML workload and contact details of the owner (e.g., a user who requested initiation of the ML workload), a list of computing resources (e.g., GPUs, DPUs, tensor processing units (TPUs), etc.) that would be used while executing/performing the ML workload, the address(es) (e.g., IP addresses, domain name system (DNS) references, etc.) of storage services (provided by the storage (106)) used for checkpointing (discussed below), the address(es) (e.g., IP addresses, DNS references, etc.) of storage services (provided by the storage (106)) used for data loading, information related to the ML workload in overall network traffic enabled by the network fabric (130) (e.g., information indicating that what JID tagging method/approach should be applied for the ML workload (said another way, the information that needs to be considered by the JID correlation module (105) while generating JID for the ML workload)), etc.

In one or more embodiments, ML model training involves multiple processes/steps. Two such processes that have an impact on the performance of ML model training are checkpointing and loading of “training” data into processing units (e.g., GPUs, DPUs, etc.). Checkpointing refers to the process of saving the intermediate states or parameters (also referred to as checkpoint data) of an ML model during training at regular intervals. This allows the training process to be paused and resumed from a saved point without having to start over, ensuring that progress is not lost due to interruptions, for example, due to computing resource failures, time limits, or other constraints. Checkpointing is a crucial aspect of training large and complex ML models, particularly in deep learning, where training can take a long time and involve extremely large datasets.

Further, the amount of time that a given processing unit is paused is directly related to the amount of time required to transmit the checkpoint data from the unit to persistent storage, where the persistent storage (e.g., 106) may be located outside of the IN (e.g., 140A) on which the unit is executing. The amount of time required is most significantly affected (or impacted) by latency in the network path (which may include multiple hops) between the IN and the storage. Any decrease in the amount of time a processing unit is paused during the checkpointing process may improve the utilization of the unit and, as a result, decrease the amount of time required to, for example, train an ML model and decrease the amount of computing resources expended to train the ML model.

In one or more embodiments, the information related to the ML workload (in the overall network traffic) may be used, by the telemetry collector (120), to correlate ML workloads and associated network traffic (flowing across the network fabric (130)). Further, this information (which needs to be considered by the JID correlation module (105) while generating a JID for the ML workload) may specify one or more approaches (e.g., JID tagging approaches, methodologies/mechanisms to label network traffic related to the ML workload, etc.) to consider (discussed below).

In one or more embodiments, as being an opaque identifier, a JID may provide a unique key through which attributes of an ML workload (e.g., network traffic related to the ML workload, collective communication messages related to the ML workload, etc.) can be correlated. In some use cases, it may be possible to carry a JID in each network packet, but in other use cases, a JID may need to be represented/recovered through other information related to an ML workload.

In one or more embodiments, whenever a data packet is identified using one of the mechanisms identified below, the identifying device (e.g., a NIC/DPU/GPU transmitting or receiving the packet, a network switch forwarding the packet, etc.) may log the transmission of monitored JIDs to an appropriate logging service (e.g., the network fabric manager (115)), or may stream the count of identified data packets, along with additional metadata (e.g., timestamp), to a telemetry target (e.g., the telemetry collector (120) (if the telemetry collector has enough computing resources to process incoming data), the network fabric manager (115) (if the telemetry collector does have enough computing resources to process incoming data), etc.) using the remote procedure call (RPC) protocol or other streaming protocols.

In one or more embodiments, the information (that is sent by the MLOps framework (e.g., 202, FIG. 2) and needs to be considered by the JID correlation module (105) while generating/determining a JID for a specific ML workload) may specify that: (i) each data packet should include the JID in order to track the ML workload using a packet embedding approach and (ii) while using this packet embedding approach (Approach 1), the JID should be embedded into a virtual network header (e.g., a virtual extensible local-area network (VXLAN)) of each data packet, as part of a corresponding network identifier (e.g., a virtual network instance (VNI)).

In one or more embodiments, while using the aforementioned packet embedding approach, the VXLAN VNI may be used to identify the network traffic (related to the ML workload), but other transports options (e.g., the ultra Ethernet transport (UET) option) may choose to use a different method. More specifically, while using Approach 1, any option that provides/satisfies the following parameters may be used to identify the network traffic: (i) the transport option should allow each unit of data transmission (e.g., a data packet, a data sequence, a data flow, etc.) to be tagged with an identifier (e.g., the JID of the ML workload) that can be used to identify the entity responsible for initiating the traffic, (ii) the offset of the JID inside of each unit of data transmission should be predictable and lend itself to hardware level interpretation at network speeds in excess of 800 gigabits per second (Gbps) or 10 million packets per second, and (iii) the transport option should allow all units of data transmission (for a particular ML workload) to be handled in a unique way (in other words, if a particular ML workload has a higher priority than other workloads, all units of data transmission associated with the higher priority ML workload should get a preferential treatment (e.g., shorter queues, lower latency, etc.)).

In one or more embodiments, while using Approach 1, the JID can be injected/embedded into each data packet (at a fixed offset into the corresponding data frame) using, for example, the programming protocol-independent packet processors (P4) code (or other packet processing code) executing on the source processing unit (e.g., a DPU/NIC of the source IN, a GPU/NIC of the source IN, etc.), which is configured by the scheduler (e.g., 206, FIG. 2) of the source IN to embed the JID (of the ML workload) when the ML workload is initiated. Further, the JID may be stripped out by a similar implementation on the receiving/target processing unit of the target IN.

In one or more embodiments, the information (that is sent by the MLOps framework (e.g., 202, FIG. 2) and needs to be considered by the JID correlation module (105) while generating/determining a JID for a specific ML workload) may specify that: (i) each data packet should include the JID in order to track the ML workload using a packet embedding approach and (ii) while using this packet embedding approach (Approach 2), the JID should be represented by a UDP source port (e.g., an RDMA over an Ethernet network version 2 (RoCE2) UDP source port for each processing unit of a corresponding IN) (so that there would be no extra overhead to the transmitted data).

As used herein, RoCE is a network protocol that enables RDMA over an Ethernet network. RoCE2 protocol packets can carry an IP header that allows traversal of IP Layer 3 routers. RoCE2 protocol packets can also carry a UDP header that acts as a stateless encapsulation layer for RDMA transport protocol packets over IP.

In one or more embodiments, there may be scenarios where adding an additional data element to a data packet may be impractical. For those scenarios, as an alternative approach, the source port of the RoCE traffic can be used by representing the JID by a UDP source port (assuming that the data packet transport would be performed using the RoCE2 (said another way, RoCE2 packets would be transported using the UDP)).

In one or more embodiments, the UDP source port for a data packet in a RoCE2 connection may carry the JID (as an opaque flow identifier allocated by the source IN). To this end, upon receiving the JID (of the ML workload) from the JID correlation module (105), the network fabric manager (115) configures a set of network devices (e.g., 132A, 132N, etc.) of the network fabric (130), based on the JID, to identify RoCE2 network traffic emanating from a particular address/source port, in which any counts of identified data packets are logged or streamed by the set of network devices (to, for example, the telemetry collector (120), see Step 312 of FIG. 3.1).

In one or more embodiments, it may be necessary to use another approach in conjunction with Approach 2 if network traffic information need be gathered for communications not using the RoCE2. For example, checkpoint data and training data may not require using the RoCE2 to communicate with the storage (106). In this example, the source/destination address match can be used to augment the source port identifier for non-RoCE network traffic.

In one or more embodiments, the information (that is sent by the MLOps framework (e.g., 202, FIG. 2) and needs to be considered by the JID correlation module (105) while generating/determining a JID for a specific ML workload) may specify that: (i) each data packet should include the JID in order to track the ML workload using a packet embedding approach and (ii) while using this packet embedding approach (Approach 3), the JID should be represented by a partition key (e.g., a RoCE2 partition key) (so that there would be no extra overhead to the transmitted data).

In one or more embodiments, the partition key may be a field (e.g., a 16-bit field) of a related transport header, which may be included in the data payload transported in a RoCE2 frame. While RoCE2 compliant processing units (e.g., GPUs, DPUs, etc.) and NICs (e.g., 208, FIG. 2) may need to verify the “partition key” field in accordance with related networking communication standards, the field is not processed by Ethernet switches in the network fabric (130), thus the field may not be used for any routing decisions and the field's value does not otherwise impact Ethernet traffic of the network fabric (130).

In one or more embodiments, the information (that is sent by the MLOps framework (e.g., 202, FIG. 2) and needs to be considered by the JID correlation module (105) while generating/determining a JID for a specific ML workload) may specify that: (i) each data packet should include the JID in order to track the ML workload using a packet embedding approach and (ii) while using this packet embedding approach (Approach 4), the JID should be embedded into a TCP option of a corresponding TCP packet header (e.g., an optional field of the TCP packet header (e.g., the TCP Options Field)).

In one or more embodiments, the TCP Options Field may provide a means to define experimental/vendor specific packet header options to be used. While Approach 4 may add some overhead to the transmitted data packets, Approach 4 may offer more space to represent the JID and associated information (described below).

In one or more embodiments, associated information may specify (or include), for example (but not limited to): a type of a collective communication function executed for the ML workload, a characteristic/attribute of the ML workload, a type of the ML workload, a type of data that is generated by executing the ML workload, a number of bytes to encode JID, a number of bytes to encode a collective communication function, a number of bytes to encode the type of the ML workload, etc.

In one or more embodiments, the scheduler (e.g., 206, FIG. 2) of a corresponding IN may use the TCP to perform for collective communication data transfers. In other embodiments, the scheduler (e.g., 206, FIG. 2) of a corresponding IN may use TCP sockets for “control plane” messaging.

More specifically, network traffic generated by schedulers/CCLs can be classified as “control traffic” and “collective communication functions traffic.” For example, control traffic can be used to initiate a collective communication function across multiple INs (e.g., aggregate a set of GPUs to execute an ML workload in parallel (“bootstrap”)). In some cases, the scheduler of the corresponding IN may use a TCP/IP socket to send control plane traffic/messages. In other cases, the scheduler of the corresponding IN may use the RoCE2 to execute collective communication functions. Approach 4 can be used in either case.

In one or more embodiments, the information (that is sent by the MLOps framework (e.g., 202, FIG. 2) and needs to be considered by the JID correlation module (105) while generating/determining a JID for a specific ML workload) may specify that: (i) each data packet should include the JID in order to track the ML workload using a packet embedding approach and (ii) while using this packet embedding approach (Approach 5), the JID should be embedded into an IP header options field of an Internet protocol version 4 (IPv4) packet header or an Internet protocol version 6 (IPv6) field packet header.

In one or more embodiments, both IPv4 and IPv6 may provide a means to specify “options”: (i) the IPv4 may provide a variable length options field of the packet header and (ii) the IPv6 may provide extension headers. In either case, the related networking communication standards may define “experimental” option identifiers, which can be used to carry the JID. Alternatively, the standards can be extended with collective communication specific option fields (IPv4) or extension headers (IPv6). For this reason, Approach 5 may add extra overhead to the transmitted data packets. More specifically, while the maximum data packet size for both IPv4 and IPv6 is 64 kilobytes (kB), the actual impact of the overhead depends on the transported data payload (e.g., typical RoCE2 packets are 4 kB, while typical TCP packets used for collective communication messages may be much larger (64 kB)).

In one or more embodiments, the information (that is sent by the MLOps framework (e.g., 202, FIG. 2) and needs to be considered by the JID correlation module (105) while generating/determining a JID for a specific ML workload) may specify that: (i) because embedding the JID into each packet is not possible, an IP tuple should be used to track the ML workload (and network traffic associated with the ML workload) and (ii) the IP tuple may be used as a proxy to identify data packets associated with the ML workload, in which the IP tuple may include/specify a source IP address (along with a related protocol and a source port) of a related data packet and a target IP address (along with a related protocol and a target port) of the data packet.

In this “IP tuple” approach (Approach 6) and comparing to Approaches 1-5 (where the JID is embedded into each data packet), when a communicator (e.g., a set of processing units such as a set of GPUs) is generated, an IP address may be assigned to each processing unit. Rather than figuring out (from each data packet) what is the JID, information (e.g., source/destination IP addresses of related processing units, the protocol that is being used by those units, source/destination ports of those units, etc.) about identified data packets may need to be analyzed separately.

From a different perspective, in Approach 6, data packets with an IP tuple (and a VXLAN identifier, if appropriate) matching the information provided to the JID correlation module (105) (when the ML workload was started) may be identified as the packets flow through network devices (e.g., 132A, 132N, etc.) of the network fabric (130). In one or more embodiments, information about the identified packets may be streamed to the telemetry collector (120) for processing (if the telemetry collector has enough computing resources to process the identified packets in real-time), using, for example, the remote RPC protocol, or may be logged (e.g., in batches in a related storage to be sent later, in which the packets may be access-protected for a transmission from the storage to the telemetry collector (using encryption)). The telemetry collector (120) may process the identified packets (a) in real-time using a related streaming protocol or (b) on a schedule or on demand.

In one or more embodiments, if the telemetry collector (120) has not enough computing resources to process the identified packets in real-time, the identified packets may be streamed (e.g., by the network devices (e.g., 132A, 132N, etc.) of the network fabric (130) or by the telemetry collector (120)) to the network fabric manager (115) for processing in non-real-time (by considering, at least, when the ML workload is initiated and when a set of processing units is assigned to the ML workload).

In one or more embodiments, Approach 6 may be impractical for monitoring traffic on heavily-used, large-scale fabrics (e.g., a large scale-out network), where network devices may struggle to maintain performance while monitoring upwards of a million or more IP tuple combinations for a system with, for example, 1024 GPUs. In this case, other options can be used. For example, the use of rail or optimized-rail topologies may place some guardrails around Approach 6, as the use of these topologies may significantly limit the number of IP address pairs that would need to be maintained by each network device port. In one or more embodiments, Approach 6 may be appropriate for storage and/or access networks, where the RoCE2 option may not be available and the demands on a network device are significantly lower.

In one or more embodiments, the information (that is sent by the MLOps framework (e.g., 202, FIG. 2) and needs to be considered by the JID correlation module (105) while generating/determining a JID for a specific ML workload) may specify that the JID would be carried/added in each collective communication message (Approach 7), in which a collective communication message may include a set of data packets of the ML workload and a corresponding network device (e.g., 132A, 132N, etc.) may label each collective communication message with the JID.

In one or more embodiments, as an alternative approach to an out-of-message indication (or “packet embedding” approaches discussed above (Approaches 1-5)), an in-message indicator may be used to indicate/represent the JID. While using an in-message indicator (Approach 7) may be less convenient (as the value is part of the collective communication data frame, rather than the packet header), the in-message indicator may provide a mechanism by which the JID can be carried in each collective communication message if there is no other convenient location in the packet to include this indicator.

In one or more embodiments, in order to accommodate/support implementations of GPU-to-GPU communications (in terms of Approach 7), adding the JID to each collective communication message may involve, for example, (i) injecting the JID into a related GPU(s) or (ii) having a related NIC(s) (e.g., 208, FIG. 2) to infer the semantics of used messaging protocols.

In one or more embodiments, different implementations may use more than one of the aforementioned approaches. For example, a scheduler (e.g., 206, FIG. 2) of a related IN may use (i) the RoCE2 to exchange collective communication messages and (ii) TCP/IP sockets for “control plane” (e.g., bootstrap) traffic. In this case, the JID tagging can be done using a partition key in RoCE2 data packets and the TCP packet header option. Alternatively, a specific VXLAN identifier can be used for tagging all network traffic that corresponds to a specific JID, or the IP option field can be used for both the RoCE2 and TCP network traffic.

In one or more embodiments, the JID correlation module (105) may be implemented as a computing device (e.g., 400, FIG. 4). The computing device may be, for example, a mobile phone, a tablet computer, a laptop computer, a desktop computer, a server, a distributed computing system, or a cloud resource. The computing device may include one or more processors, memory (e.g., RAM), GPUs, NPUs, TPUs, and persistent storage (e.g., HDDs, SSDs, etc.). The computing device may include instructions, stored in the persistent storage, that when executed by the processor(s) of the computing device cause the computing device to perform the functionality of the JID correlation module (105) described throughout the application.

Alternatively, in one or more embodiments, similar to a client (e.g., 110A, 110N, etc.), the JID correlation module (105) may also be implemented as a logical device.

In one or more embodiments, as being a physical computing device or a logical computing device, the telemetry collector (120) may include functionality to perform all, or a portion, of the functionalities described in FIGS. 3.1-3.2. One of ordinary skill will appreciate that the telemetry collector (120) may perform other functionalities without departing from the scope of the embodiments disclosed herein.

In one or more embodiments, the telemetry collector (120) may be implemented as a computing device (e.g., 400, FIG. 4). The computing device may be, for example, a mobile phone, a tablet computer, a laptop computer, a desktop computer, a server, a distributed computing system, or a cloud resource. The computing device may include one or more processors, memory (e.g., RAM), GPUs, NPUs, TPUs, and persistent storage (e.g., HDDs, SSDs, etc.). The computing device may include instructions, stored in the persistent storage, that when executed by the processor(s) of the computing device cause the computing device to perform the functionality of the telemetry collector (120) described throughout the application.

Alternatively, in one or more embodiments, similar to a client (e.g., 110A, 110N, etc.), the telemetry collector (120) may also be implemented as a logical device.

In one or more embodiments, all, or a portion, of the components of the system (100) may be operably connected each other and/or other entities via any combination of wired and/or wireless connections. For example, the aforementioned components may be operably connected, at least in part, via a network (e.g., a scale-out network or any other network topology) that is enabled by the network fabric (130) (more specifically, enabled by the network devices (e.g., 132A, 132N, etc.) of the network fabric (130)). Further, all, or a portion, of the components of the system (100) may interact with one another using any combination of wired and/or wireless communication protocols.

In one or more embodiments, a scale-out network may be a distributed networking architecture designed to handle increases in data traffic and workloads by adding more resources (e.g., INs, network devices (e.g., 132A, 132N, etc.), etc.). The components of the scale-out network may be connected via the network fabric (130). As used herein, a network fabric may refer to the interconnected topology and structure of network components/devices (e.g., switches, routers, links, etc.) in the scale-out network that operate together to provide high-speed, low-latency data transmission across the system (100).

In one or more embodiments, the network fabric (130) may be implemented using a spine-leaf topology, in which every leaf network device connects to each spine network device. Each component of the system (100) may directly connect to the leaf network devices via one or more top-of-rack switches.

In one or more embodiments, the network may represent a (decentralized or distributed) computing network and/or fabric configured for computing resource and/or messages exchange among registered computing devices (e.g., the clients, the IN, the storage, etc.). As discussed above, components of the system (100) may operatively connect to one another through the network (e.g., a SAN, a personal area network (PAN), a LAN, a metropolitan area network (MAN), a WAN, a mobile network, a wireless LAN (WLAN), a virtual private network (VPN), an intranet, the Internet, etc.) enabled by the network fabric (130), which facilitates the communication of signals, data, and/or messages. In one or more embodiments, the network may be implemented using any combination of wired and/or wireless network topologies, and the network may be operably connected to the Internet or other networks. Further, the network may enable interactions between, for example, the clients and the INs through any number and type of wired and/or wireless network protocols (e.g., TCP, UDP, IPv4, etc.).

As discussed above, the network (or the network fabric (130)) may encompass various interconnected, network-enabled subcomponents (132A, 132N) (e.g., switches, routers, gateways, cables etc.) that may facilitate communications between the components of the system (100). In one or more embodiments, the network-enabled subcomponents may be capable of: (i) performing one or more communication schemes (e.g., IP communications, Ethernet communications, etc.), (ii) being configured by one or more components in the network, and (iii) limiting communication(s) on a granular level (e.g., on a per-port level, on a per-sending device level, etc.). The subcomponents (e.g., network devices) may be implemented using hardware, software, or any combination thereof.

In one or more embodiments, before communicating data over the network fabric (130), the data may first be broken into smaller batches (e.g., data packets) so that larger size data can be communicated efficiently. For this reason, the network-enabled subcomponents may break data into data packets. The network-enabled subcomponents may then route each data packet in the network fabric (130) to distribute network traffic uniformly.

In one or more embodiments, the network-enabled subcomponents (in conjunction with the network fabric manager (115)) may decide how real-time network traffic and non-real-time network traffic should be managed in the network fabric (130). In one or more embodiments, the real-time network traffic may be high-priority (e.g., urgent, immediate, etc.) network traffic. For this reason, data packets of the real-time network traffic may need to be prioritized in the network fabric (130). The real-time network traffic may include data packets related to, for example (but not limited to): videoconferencing, web browsing, voice over Internet Protocol (VoIP), etc.

While FIG. 1 shows a configuration of components, other system configurations may be used without departing from the scope of the embodiments disclosed herein.

Turning now to FIG. 2, FIG. 2 shows a diagram of an IN (200) in accordance with one or more embodiments disclosed herein. The IN (200) may be an example of the IN discussed above in reference to FIG. 1. The IN (200) includes the MLOps framework (202), the ML workload executable (204), and the NICs (208). The IN (200) may include additional, fewer, and/or different components without departing from the scope of the embodiments disclosed herein. Each component may be operably connected to any of the other components via any combination of wired and/or wireless connections. Each component illustrated in FIG. 2 is discussed below.

In one or more embodiments, as being a physical computing device or a logical computing device, the MLOps framework (202) may include functionality to, at least: (i) manage ML operations (e.g., experiment tracking to identify the best ML model, deploying ML models to production and making them accessible to applications, monitoring ML models to detect any issues or degradation in performance, retraining ML models with newer data to improve their performance, etc.); (ii) receive a unique JID (that is generated for a specific ML workload) from the JID correlation module (e.g., 105, FIG. 1); and/or (iii) provide the JID to the scheduler (206).

One of ordinary skill will appreciate that the MLOps framework (202) may perform other functionalities without departing from the scope of the embodiments disclosed herein. The MLOps framework (202) may be implemented as a computing device using hardware (e.g., any number of integrated circuits for processing computer readable instructions), software (e.g., a computer program), or any combination thereof.

In one or more embodiments, the ML workload executable (204) may host the scheduler (206). One of ordinary skill will appreciate that the ML workload executable (204) may perform other functionalities without departing from the scope of the embodiments disclosed herein. The ML workload executable (204) may be implemented as a computing device using hardware (e.g., any number of integrated circuits for processing computer readable instructions), software (e.g., a computer program), or any combination thereof.

In one or more embodiments, as being a computer program, the scheduler (206) may include functionality to, at least: (i) receive a JID (that is generated for a specific ML workload) from the MLOps framework (202); (ii) use/employ the JID to label/tag telemetry data (e.g., for collective communication functions/messages) associated with the ML workload; (iii) provide the “ML workload” telemetry data (related to the JID) to the telemetry collector (e.g., 120, FIG. 1); and/or (iv) configure NICs (208) of the IN (200) to embed/inject the JID in network traffic (within the network fabric (e.g., 130, FIG. 1)) associated with/to the ML workload.

In one or more embodiments, the scheduler (206) may be a library that is designed to optimize communications between processing units (e.g., GPUs, DPUs, etc.) in the IN (200), acting as a communicator so that processing units can communicate efficiently. In order to act as a communicator, the scheduler (206) may set up a communication context that allows the processing units to communicate efficiently. In one or more embodiments, the communicator lifecycle for the scheduler (206) may be managed by a control panel of the IN (200) based on the following steps: (i) initialization (in this step, the scheduler (206) needs to be initialized, by setting up the environment and ensuring that necessary processing units are available), (ii) generating the communicator, (iii) synchronizing the ranks (in this step, all ranks (e.g., the processing units) need to be synchronized (e.g., using a barrier synchronization) so that they are ready to communicate, (iv) communication (in this step, once the communicator is set up, scheduler functions can be used to perform collective communication functions), and (v) finalization (in this step, after the communication tasks are completed, the communicator should be terminated to free up computing resources).

In one or more embodiments, the scheduler (206) may collect metrics (e.g., ML workload telemetry data) for the type of collective communication functions, collective communication transmission protocols, and messages (e.g., int8, float32, etc.). In addition to associating (e.g., by the network fabric (e.g., 130, FIG. 1)) a JID with network traffic of a related ML workload, the JID can also be used to label (e.g., by the scheduler and/or the network fabric) all collective communication functions'counters for the ML workload. In this manner, for the ML workload, this association may enable a central correlation and monitoring service (e.g., the telemetry collector (e.g., 120, FIG. 1)) to easily associate collective communication functions with the network traffic that they generate.

One of ordinary skill will appreciate that the scheduler (206) may perform other functionalities without departing from the scope of the embodiments disclosed herein.

In one or more embodiments, as being a physical computing device or a logical computing device, a NIC of the NICs (208) may provide functionalities to interface the IN (200) with one or more other devices in the system (e.g., 100, FIG. 1) and allow for the transmission and receipt of data (including metadata) with those device(s). A NIC of the NICs (208) (e.g., a communication interface) may communicate via any suitable form of wired interface (e.g., Ethernet, fiber optic, serial communication etc.) and/or wireless interface and utilize one or more protocols for the transmission and receipt of data (e.g., TCP/IP, RDMA, RoCE, IEEE 801.11, etc.).

In one or more embodiments, a NIC of the NICs (208) may implement and/or support one or more protocols to enable the communication between the IN (200) with one or more other devices (e.g., other INs in the system, one or more clients, etc.). For example, the NIC may enable the IN (200) to be operatively connected, via Ethernet, using a TCP/IP protocol to form a “network fabric” and enable the communication of data between the IN (200) and other external entities. In one or more embodiments, each IN within the system (e.g., 100, FIG. 1) may be given a unique identifier (e.g., an IP address) to be used when utilizing one or more protocols.

One of ordinary skill will appreciate that a NIC of the NICs (208) may perform other functionalities (e.g., being used by a GPU and/or a DPU of the IN (200)) without departing from the scope of the embodiments disclosed herein. The NIC may be implemented as a computing device using hardware (e.g., any number of integrated circuits for processing computer readable instructions), software (e.g., a computer program), or any combination thereof.

In one or more embodiments, the MLOps framework (202), the scheduler (206), and the NICs (208) may be utilized in isolation and/or in combination to provide the aforementioned functionalities. These functionalities may be invoked using any communication model including, for example, message passing, state sharing, memory sharing, etc.

FIGS. 3.1-3.2 show a method for managing performance of an ML workload in accordance with one or more embodiments disclosed herein. While various steps in the method are presented and described sequentially, those skilled in the art will appreciate that some or all of the steps may be executed in different orders, may be combined or omitted, and some or all steps may be executed in parallel without departing from the scope of the embodiments disclosed herein.

Turning now to FIG. 3.1, the method shown in FIG. 3.1 may be executed by, for example, the above-discussed JID correlation module (e.g., 105, FIG. 1), scheduler (e.g., 206, FIG. 2), and telemetry collector (e.g., 120, FIG. 1). Other components of the system (100) illustrated in FIG. 1 may also execute all or part of the method shown in FIG. 3.1 without departing from the scope of the embodiments disclosed herein.

In Step 300, the JID correlation module detects that an ML workload is initiated/scheduled in an IN (e.g., 140A, FIG. 1), in which the JID correlation module and the IN may be operatively connected to each other over a network fabric (e.g., 130, FIG. 1). In one or more embodiments, upon receiving a workload initiation request associated with the ML workload from the MLOps framework (e.g., 202, FIG. 1), the JID correlation module may detect that the ML workload is initiated in the IN. In the request, the MLOps framework may specify information that needs to be considered by the JID correlation module while generating the JID.

For example, if the ML workload would be using “packet embedding,” to trace network traffic associated with the ML workload, the JID may be limited to 16 bits (in order to reduce the additional information that needs to be embedded into corresponding data packets).

In Step 302, upon detecting that the ML workload is initiated in the IN, the JID correlation module generates a unique JID for the ML workload. In one or more embodiments, the ML workload may be initiated upon receiving a request from a user of a client (e.g., 110A, FIG. 1). Further, the JID may be used to, at least, (a) track the ML workload and collective communication traffic across the network fabric (e.g., 130, FIG. 1) and (b) correlate these traffic flows with the corresponding ML workload (and its activities). In one or more embodiments, the JID correlation module may be queried by the user to infer/determine details of the ML workload.

In Step 304, the JID correlation module provides the unique JID (and JID tagging method, as “environment variables”) to the scheduler, via the MLOps framework, and to the telemetry collector (along with, for example, IP address of each processing unit, network device of the network fabric, and NIC that would be associated with the ML workload). In one or more embodiments, the JID tagging method (to be used for the ML workload) may be selected, based on system-wide knowledge of the network devices/NICs (e.g., of the IN and/or the network fabric) and scheduler implementations, by the JID correlation module.

In Step 306, the scheduler uses the JID to label/tag telemetry data (e.g., how many collective communication functions have been executed, a type of each function, etc.) associated with the ML workload (the “ML workload” telemetry data). Said another way, the scheduler uses the JID to label collective communication messages associated with the ML workload.

In Step 308, the scheduler provides the ML workload telemetry data (related to the JID) to the telemetry collector. In Step 310, the scheduler configures NICs (e.g., 208, FIG. 2) of the IN to embed/inject the JID in network traffic (within the network fabric) associated with/to the ML workload. In one or more embodiments, the JID may be used to track the ML workload across the network fabric and network devices (e.g., 132A, 132N, FIG. 1) of the network fabric may be configured by the network fabric manager based on the JID. Separately, network devices (e.g., 132A, 132N, FIG. 1) of the network fabric and/or the telemetry collector may also use the same JID (or the same JID representation) to track, collect information, and correlate JID telemetry data (e.g., the ML workload telemetry data) with network traffic telemetry data.

To this purpose, the network devices of the network fabric may collect timestamped network traffic counters (including, at least, packet errors and congestion counters) associated with the JID (e.g., the number of RDMA packets associated with the JID (per unit of time), the number of VXLAN packets associated with the JID (per unit of time), etc.), while the scheduler may collect timestamped counters associated to the JID (or the ML workload) (e.g., the number of “all reduce” functions (per unit of time) for the JID). Thereafter, these counters may be sent to the telemetry collector (by the corresponding network devices and/or the scheduler), which aggregates all counters and correlates network traffic telemetry data with the ML workload telemetry data, based on the JID.

In Step 312, the telemetry collector receives the “network traffic” telemetry data (related to the JID) from network devices of the network fabric and the NICs of the IN. In one or more embodiments, based on the JID, the network traffic (of the ML workload) may be prioritized by the network devices of the network fabric (because, for example, the ML workload is a high-priority workload).

In Step 314, the telemetry collector correlates (in real-time or near real-time) the ML workload telemetry data with the network traffic telemetry data using the JID. Based on the correlation, the telemetry collector may infer, for example (but not limited to): the JID is being executed/used by certain set of processing units of the IN (so that computing resources that are being utilized to perform the ML workload can be determined), individual data packets related to the JID (and, hence, to the ML workload), etc. If the telemetry collector does not have enough computing resources to perform the correlation, the telemetry collector may provide the ML workload telemetry data along with the network traffic telemetry data to the network fabric manager (e.g., 115, FIG. 1), in which the network fabric manager may analyze the obtained data and perform (non-real-time) correlation. Following Step 314, the method proceeds to Step 316 of FIG. 3.2.

Turning now to FIG. 3.2, the method shown in FIG. 3.2 may be executed by, for example, the above-discussed telemetry collector and MLOps framework (e.g., 202, FIG. 2). Other components of the system (100) illustrated in FIG. 1 may also execute all or part of the method shown in FIG. 3.2 without departing from the scope of the embodiments disclosed herein.

In Step 316, based on the correlation performed in Step 314 of FIG. 3.1, the telemetry collector makes a determination (in real-time or near real-time) as to whether an issue with respect to the performance of the network traffic and/or collective communication messages are detected (e.g., as to whether a discrepancy/issue in the ML workload telemetry data or in the network traffic telemetry data is detected). Accordingly, in one or more embodiments, if the result of the determination is YES, the method proceeds to Step 318. If the result of the determination is NO, the method proceeds to Step 322.

In Step 318, as a result of the determination in Step 316 being YES, the telemetry collector infers that there is an issue (e.g., a congestion, a performance bottleneck, etc.) in the network traffic (that is enabled by the network fabric) related to the ML workload. For example, using the JID, (a) the ML workload may be identified as the cause of the congestion, and the network devices (of the network fabric) may be identified not the cause of the congestion, or (b) the network devices (of the network fabric) may be identified as the cause of the congestion, and the ML workload may be identified not the cause of the congestion.

In Step 320, based on the inferring (in Step 318) and using a GUI of the client, the telemetry collector initiates: (i) (if the ML workload is identified as the cause of the congestion) notifying of the user (or a network administrator) to indicate that the ML workload is causing the congestion and recommend troubleshooting the ML workload for errors/delays, or (ii) (if a network device of the network fabric is identified as the cause of the congestion) notifying of the user (or the network administrator) to indicate that the network device of the network fabric is causing the congestion and recommend troubleshooting the network device for errors/delays (e.g., recommend replacing a degrading network device of the set of network devices with a healthy network device). Thereafter, upon receiving the administrator's approval on replacing the degrading network device, the telemetry collector may send a network device replacement request to the network fabric manager and, upon receiving the network device replacement request, the network fabric manager may replace the degrading network device with the healthy network device.

For example, consider a scenario where User A has submitted an ML model training workload that is taking much longer to complete than expected. After using an ML stack profiler to profile the workload, User A determines that the training time (of the model) is being dominated by training data transfer times. Based on the determination, User A can reach out to the networking team administrator, provide the JID of the ML workload, and request the administrator to investigate the cause of the issue. The administrator may use the JID to associate the ML job with packets on the network to determine the cause.

As yet another example, consider a scenario where User B has submitted an ML workload that is taking much longer to complete than expected. Since the ML workload was executed with no issues on the development environment, User B assumes that the network fabric is the cause of the issue. After reporting the issue to the networking team administrator, the administrator can use the JID of the ML workload to quickly determine the data packet flows (associated with the ML workload) across the network and confirm that the network (or the network devices of the network fabric) is not the cause of the issue. Based on this, the administrator may notify User B to troubleshoot the ML workload for bottlenecks.

As yet another example, consider a scenario where Network Administrator A identifies congestion in the network. Based on the JID (and with the help of the telemetry collector), Network Administrator A can determine one or more ML workloads impacted by the congestion. Network Administrator A may use this information proactively to notify a corresponding user about the issue and help the user to triage and/or troubleshoot the issue. In one or more embodiments, the method may end following Step 320.

In Step 322, as a result of the determination in Step 316 being NO, the telemetry collector notifies the MLOps framework to indicate that no issue found in the network traffic related to the ML workload. In Step 324, when the ML workload is completed, the MLOps framework: (i) notifies the JID correlation module to indicate that the ML workload is completed and (ii) removes the ML workload from a set of active workloads. In one or more embodiments, the method may end following Step 324.

Turning now to FIG. 4, FIG. 4 shows a diagram of a computing device in accordance with one or more embodiments disclosed herein.

In one or more embodiments disclosed herein, the computing device (400) may include one or more computer processors (402), non-persistent storage (404) (e.g., volatile memory, such as RAM, cache memory), persistent storage (406) (e.g., a non-transitory computer readable medium, a hard disk, an optical drive such as a CD drive or a DVD drive, a Flash memory, etc.), a communication interface (412) (e.g., Bluetooth interface, infrared interface, network interface, optical interface, etc.), an input device(s) (410), an output device(s) (408), and numerous other elements (not shown) and functionalities. Each of these components is described below.

In one or more embodiments, the computer processor(s) (402) may be an integrated circuit for processing instructions. For example, the computer processor(s) (402) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (e.g., a LAN, a WAN, Internet, mobile network, etc.) and/or to another device, such as another computing device.

In one or more embodiments, the computing device (400) may include one or more output devices (408), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

The problems discussed throughout this application should be understood as being examples of problems solved by embodiments described herein, and the various embodiments should not be limited to solving the same/similar problems. The disclosed embodiments are broadly applicable to address a range of problems beyond those discussed herein.

One or more embodiments disclosed herein may be implemented using instructions executed by one or more processors of a computing device. Further, such instructions may correspond to computer readable instructions that are stored on one or more non-transitory computer readable mediums.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for managing performance of a machine learning workload (MLW), the method comprising:
detecting, by a job identifier correlation module (JIDCM), that the MLW is initiated in a node,
wherein the JIDCM and the node are operatively connected to each other over a network fabric;
generating, based on the detecting and by the JIDCM, a job identifier (JID) for the MLW, wherein the MLW is initiated upon receiving a request from a user;
providing, by the JIDCM, the JID to a scheduler via an ML operations (MLOps) framework,
wherein, upon receiving a workload initiation request associated with the MLW from the MLOps framework, the JIDCM detects that the MLW is initiated in the node,
wherein, in the workload initiation request, the MLOps framework specifies information that needs to be considered by the JIDCM while generating the JID;
using, by the scheduler, the JID to label ML workload telemetry data associated with the MLW, wherein the ML workload telemetry data is sent to a telemetry collector (TC);
configuring, by the scheduler, a network interface card (NIC) of the node to embed the JID in network traffic associated with the MLW,
wherein the JID would be used to track the MLW across the network fabric;
receiving, by the TC, network traffic telemetry data related to the JID from a set of network devices of the network fabric and the NIC of the node;
correlating, by the TC, the ML workload telemetry data with the network traffic telemetry data using the JID;
making, based on the correlating and by the TC, a determination that there is an issue in the ML workload telemetry data or in the network traffic telemetry data;
inferring, based on the determination and by the TC, that there is a congestion in the network traffic,
wherein, using the JID, the MLW is identified as a cause of the congestion and the set of network devices is identified as not the cause of the congestion;
notifying, based on the inferring and using a graphical user interface of the TC, the user to:
indicate that the MLW is causing the congestion, and
recommend troubleshooting the MLW for errors.

2. The method of claim 1,
wherein the information specifies that each data packet would comprise the JID in order to track the MLW using a packet embedding approach, and
wherein, while using the packet embedding approach, the JID would be embedded into a virtual network header of each data packet.

3. The method of claim 1,
wherein the information specifies that each data packet would comprise the JID in order to track the MLW using a packet embedding approach, and
wherein, while using the packet embedding approach, the JID would be represented by a user datagram protocol (UDP) source port.

4. The method of claim 1,
wherein the information specifies that each data packet would comprise the JID in order to track the MLW using a packet embedding approach, and
wherein, while using the packet embedding approach, the JID would be represented by a partition key.

5. The method of claim 1,
wherein the information specifies that each data packet would comprise the JID in order to track the MLW using a packet embedding approach, and
wherein, while using the packet embedding approach, the JID would be embedded into a transmission control protocol (TCP) option of a corresponding TCP packet header.

6. The method of claim 1,
wherein the information specifies that each data packet would comprise the JID in order to track the MLW using a packet embedding approach, and
wherein, while using the packet embedding approach, the JID would be embedded into an Internet Protocol (IP) header option field of an Internet protocol version 4 (IPv4) packet header or an Internet protocol version 6 (IPv6) field packet header.

7. The method of claim 1,
wherein the information specifies that, because embedding the JID into each packet is not possible, an Internet Protocol (IP) tuple would be used to track the MLW,
wherein the IP tuple would be used as a proxy to identify data packets associated with the MLW, and
wherein the IP tuple comprises a source IP address of a data packet of the data packets and a target IP address of the data packet.

8. The method of claim 1,
wherein the information specifies that the JID would be carried in each collective communication message, and
wherein a collective communication message comprises a set of data packets of the MLW.

9. The method of claim 8, wherein a corresponding network device labels each collective communication message with the JID.

10. The method of claim 1, wherein the set of network devices is configured by a network fabric manager based on the JID.

11. The method of claim 1, wherein, based on the JID, the network traffic is prioritized by the set of network devices.

12. The method of claim 1, wherein the scheduler uses the JID to label collective communication messages associated with the MLW.

13. A method for managing performance of a machine learning workload (MLW), the method comprising:
detecting, by a job identifier correlation module (JIDCM), that the MLW workload is initiated in a node,
wherein the JIDCM and the node are operatively connected to each other over a network fabric;
generating, based on the detecting and by the JIDCM, a job identifier (JID) for the MLW,
wherein the MLW is initiated upon receiving a request from a user;
providing, by the JIDCM, the JID to a scheduler via an ML operations (MLOps) framework,
wherein, upon receiving a workload initiation request associated with the MLW from the MLOps framework, the JIDCM detects that the MLW is initiated in the node,
wherein, in the workload initiation request, the MLOps framework specifies information that needs to be considered by the JIDCM while generating the JID;
using, by the scheduler, the JID to label ML workload telemetry data associated with the MLW, wherein the ML workload telemetry data is provided to a telemetry collector (TC);
configuring, by the scheduler, a network interface card (NIC) of the node to embed the JID in network traffic associated with the MLW,
wherein the JID would be used to track the MLW across the network fabric;
receiving, by the TC, network traffic telemetry data related to the JID from a set of network devices of the network fabric and the NIC of the node;
correlating, by the TC, the ML workload telemetry data with the network traffic telemetry data using the JID;
making, based on the correlating and by the TC, a determination that there is an issue in the ML workload telemetry data or in the network traffic telemetry data;
inferring, based on the determination and by the TC, that there is a congestion in network traffic that is enabled by the network fabric,
wherein, using the JID, the set of network devices is identified as a cause of the congestion and the MLW is identified as not the cause of the congestion;
notifying, based on the inferring and using a graphical user interface of the TC, a network administrator to:
indicate that the set of network devices is causing the congestion, and
recommend replacing a degrading network device of the set of network devices with a healthy network device;
sending, upon receiving the administrator's approval on replacing the degrading network device and by the TC, a network device replacement request to a network fabric manager; and
replacing, upon receiving the network device replacement request and by the network fabric manager, the degrading network device with the healthy network device.

14. The method of claim 13,
wherein the information specifies that each data packet would comprise the JID in order to track the MLW using a packet embedding approach, and
wherein, while using the packet embedding approach, the JID would be embedded into a virtual network header of each data packet.

15. The method of claim 13,
wherein the information specifies that each data packet would comprise the JID in order to track the MLW using a packet embedding approach, and
wherein, while using the packet embedding approach, the JID would be represented by a user datagram protocol (UDP) source port.

16. The method of claim 13,
wherein the information specifies that each data packet would comprise the JID in order to track the MLW using a packet embedding approach, and
wherein, while using the packet embedding approach, the JID would be represented by a partition key.

17. The method of claim 13,
wherein the information specifies that each data packet would comprise the JID in order to track the MLW using a packet embedding approach, and
wherein, while using the packet embedding approach, the JID would be embedded into a transmission control protocol (TCP) option of a corresponding TCP packet header.

18. The method of claim 13,
wherein the information specifies that each data packet would comprise the JID in order to track the MLW using a packet embedding approach, and
wherein, while using the packet embedding approach, the JID would be embedded into an Internet Protocol (IP) header option field of an Internet protocol version 4 (IPv4) packet header or an Internet protocol version 6 (IPv6) field packet header.

19. The method of claim 13,
wherein the information specifies that, because embedding the JID into each packet is not possible, an Internet Protocol (IP) tuple would be used to track the MLW,
wherein the IP tuple would be used as a proxy to identify data packets associated with the MLW, and
wherein the IP tuple comprises a source IP address of a data packet of the data packets and a target IP address of the data packet.

20. A system, the system comprising:
a job identifier correlation module (JIDCM) configured to:
detect that a machine learning workload (MLW) is initiated in a node,
generate, based on the detecting, a job identifier (JID) for the MLW, wherein the MLW is initiated upon receiving a request from a user;
provide the JID to a scheduler of a node via an ML operations (MLOps) framework,
wherein the JIDCM and the node are operatively connected to each other over a network fabric,
wherein, upon receiving a workload initiation request associated with the MLW from the MLOps framework, the JIDCM detects that the MLW is initiated in the node,
wherein, in the workload initiation request, the MLOps framework specifies information that needs to be considered by the JIDCM while generating the JID;
the scheduler configured to:
use the JID to label ML workload telemetry data associated with the MLW, wherein the ML workload telemetry data is sent to a telemetry collector (TC);
configure a network interface card (NIC) of the node to embed the JID in network traffic associated with the MLW,
wherein the JID would be used to track the MLW across the network fabric;
the TC configured to:
receive network traffic telemetry data related to the JID from a set of network devices of the network fabric and the NIC of the node;
correlate the ML workload telemetry data with the network traffic telemetry data using the JID;
make, based on the correlating, a determination that there is an issue in the ML workload telemetry data or in the network traffic telemetry data;
infer, based on the determination, that there is a congestion in the network traffic,
wherein, using the JID, the MLW is identified as a cause of the congestion and the set of network devices is identified as not the cause of the congestion;
notify, based on the inferring and using a graphical user interface, the user to:
indicate that the MLW is causing the congestion, and
recommend troubleshooting the MLW for errors.
